(19) United States
(12) Patent Application Publication
(10) Pub. No.: US 2020/0058224 A1
(43) Pub. Date: Feb. 20, 2020

(54) ROUTE INFORMATION TRANSMISSION METHOD, APPARATUS AND SYSTEM, UNMANNED AERIAL VEHICLE, GROUND STATION, AND COMPUTER READABLE STORAGE MEDIUM

(71) Applicant: Autel Robotics Europe GmbH, Ismaning (DE)

(72) Inventor: Roberto GIONA, Ismaning (DE)

(21) Appl. No.: 16/560,060

(22) Filed: Sep. 4, 2019

(30) Foreign Application Priority Data
Aug. 16, 2018 (DE) 102018120013.7

(51) Int. Cl. G08G 5/00; G05D 1/10; G05D 1/00; B64C 39/02

(52) U.S. Cl. CPC G08G 5/0034; G08G 5/006; G08G 5/0013; B64C 2201/12; G05D 1/0088; B64C 39/024; G05D 1/101

(57) ABSTRACT

The present disclosure provides a route information transmission method. The method includes: receiving route description information sent by a ground station, where the route description information includes zone information, and the zone information includes location information of a flight zone; determining a first route task corresponding to the flight zone according to the zone information; and executing the first route task in the flight zone. Zone information required for flight is sent to a UAV, so that the UAV can generate a flight route according to the zone information. Therefore, a ground station no longer needs to send complete route information to the UAV. The UAV generates the flight route automatically and then obtains a route task. As such, the data amount of information transmitted between the ground station and the UAV can be reduced, thereby improving transmission efficiency of the information and improving route execution efficiency of the UAV.

### CROSS-REFERENCE TO RELATED APPLICATION

The application claims priority of Germany Patent Application No. 102018120013.7, filed on Aug. 16, 2018, which is incorporated herein by reference in its entirety.

### BACKGROUND

### Technical Field

The present application relates to the field of unmanned aerial vehicle (UAV) technologies, and in particular, to a route information transmission method, apparatus and system, a UAV, a ground station, and a computer readable storage medium.

### Related Art

A UAV can also be referred to as an unmanned aircraft.

The UAV is under the control of a ground station, and can fly according to information sent by a ground station. For example, the ground station can generate, according to an operation of a user, route information planned by the user, and can send the route information to the UAV. The UAV determines a flight route according to the received route information and flies.

Currently, due to a limited transmission bandwidth between the ground station and the UAV, transmission efficiency of the route information is relatively low if the route information has a large amount of data, affecting the route information-based flight of the UAV.

### SUMMARY

The present application provides a route information transmission method, apparatus and system, a UAV, a ground station, and a computer readable storage medium, so as to resolve the problem that low transmission efficiency of route information affects route information-based flight of a UAV.

According to a first aspect, the present application provides a route information transmission method, applied to a UAV, including:

receiving route description information sent by a ground station, where the route description information includes zone information, and the zone information includes location information of a flight zone;

determining a first route task corresponding to the flight zone according to the zone information; and

executing the first route task in the flight zone.

With reference to the first aspect, in a first implementation of the first aspect, the determining a first route task corresponding to the flight zone according to the zone information includes:

determining location information of a start waypoint and a route shape according to the zone information; and

determining a flight route in the first route task according to the location information of the start waypoint and the route shape.

With reference to the first aspect, in a second implementation of the first aspect, the determining a first route task corresponding to the flight zone according to the zone information includes:

determining waypoint information in the flight zone according to the zone information; and

determining a flight route in the first route task according to the waypoint information.

With reference to the second implementation of the first aspect, in a third implementation of the first aspect, the determining waypoint information in the flight zone according to the zone information includes:

determining, according to the zone information, location information of a start waypoint and location information of a terminal waypoint in the flight zone.

With reference to the first aspect or any implementation of the first aspect, in a fourth implementation of the first aspect, the determining a first route task corresponding to the flight zone according to the zone information includes:

determining, according to the zone information, whether there exists a no-fly zone; and

if there exists a no-fly zone, determining a flight route that corresponds to the flight zone and avoids the no-fly zone.

With reference to the first aspect or any implementation of the first aspect, in a fifth implementation of the first aspect, after the determining a first route task corresponding to the flight zone according to the zone information, the method further includes:

obtaining flight state information; and

determining, according to the flight state information, whether the first route task meets a first execution condition;

where the executing the first route task in the flight zone includes:

executing the first route task in the flight zone if the first route task meets the first execution condition.

With reference to the fifth implementation of the first aspect, in a sixth implementation of the first aspect, the method further includes:

sending first prompt information to the ground station if the first route task does not meet the first execution condition, so as to indicate that execution of the first route task fails.

With reference to the first aspect, the first implementation of the first aspect, the second implementation of the first aspect, the third implementation of the first aspect, the fourth implementation of the first aspect, the fifth implementation of the first aspect, or the sixth implementation of the first aspect, in a seventh implementation of the first aspect, the method further includes:

in the process of executing the first route task, determining whether there exists a task that fails in execution; and

if there exists a task that fails in execution, after executing the first route task, determining a second route task according to location information corresponding to the task that fails in execution.

With reference to the seventh implementation of the first aspect, in an eighth implementation of the first aspect, the method further includes:

sending a task execution failure message to the ground station if there exists a task that fails in execution.

With reference to the eighth implementation of the first aspect, in a ninth implementation of the first aspect, the method further includes:

receiving a control instruction that is sent by the ground station with respect to the second route task; and

executing the second route task according to the control instruction.

With reference to the first aspect, the first implementation of the first aspect, the second implementation of the first aspect, the third implementation of the first aspect, the fourth implementation of the first aspect, the fifth implementation of the first aspect, or the sixth implementation of the first aspect, in a tenth implementation of the first aspect, the method further includes:

receiving updated route description information sent by the ground station, wherein the updated route description information includes updated waypoint information or updated zone information; and updating the first route task to be a third route task according to the updated route description information.

With reference to the tenth implementation of the first aspect, in an eleventh implementation of the first aspect, the method further includes:

determining, according to a current execution state of the first route task, whether the third route task meets a second execution condition;

executing the third route task if the third route task meets the second execution condition; and

sending second prompt information to the ground station if the third route task does not meet the second execution condition, so as to indicate that execution of the third route task fails.

According to a second aspect, the present application provides a route information transmission method, applied to a ground station, including:

generating zone information according to a user operation, where the zone information includes location information of a flight zone; and

sending route description information comprising the zone information to a UAV, so that the UAV determines a first route task corresponding to the flight zone according to the zone information.

With reference to the second aspect, in a first implementation of the second aspect, the method further includes:

determining the first route task corresponding to the flight zone according to the zone information; and

displaying the first route task;

where the sending route description information comprising the zone information to a UAV includes:

sending the route description information including the zone information to the UAV if a confirm operation of a user for the flight route is detected.

With reference to the second aspect or the first implementation of the second aspect, in a second implementation of the second aspect, the method further includes:

if a task execution failure message fed back by the UAV with respect to the first route task is received, determining a task that fails in execution in the first route task;

re-determining a second route task according to the task that fails in execution; and

displaying the second route task.

With reference to the second implementation of the second aspect, in a third implementation of the second aspect, the method further includes:

if a confirm operation of the user for the second route task is detected, sending a control instruction to the UAV, so that the UAV executes the second route task after receiving the control instruction.

With reference to the second aspect or the first implementation of the second aspect, in a fourth implementation of the second aspect, the method further includes:

receiving an update operation of the user for the first route task;

generating updated route description information according to the update operation, where the updated route description information includes updated waypoint information or updated zone information; and

sending the updated route description information to the UAV, so that the UAV updates the first route task to be a third route task according to the updated route description information.

According to a third aspect, the present application provides a UAV, including: a communications interface, a task controller, and a flight controller, where the communications interface and the flight controller are connected to the task controller separately;

the communications interface is configured to receive route description information sent by a ground station, and send the route description information to the task controller, where the route description information includes zone information, and the zone information includes location information of a flight zone;

the task controller is configured to determine a first route task corresponding to the flight zone according to the zone information, and send the first route task to the flight controller; and

the flight controller is configured to execute the first route task in the flight zone.

With reference to the third aspect, in a first implementation of the third aspect, the task controller is specifically configured to:

determine location information of a start waypoint and a route shape according to the zone information; and

determine a flight route in the first route task according to the location information of the start waypoint and the route shape.

With reference to the third aspect, in a second implementation of the third aspect, the task controller is specifically configured to:

determine waypoint information in the flight zone according to the zone information; and

determine a flight route in the first route task according to the waypoint information.

With reference to the second implementation of the third aspect, in a third implementation of the third aspect, the task controller is specifically configured to:

determine, according to the zone information, location information of a start waypoint and location information of a terminal waypoint in the flight zone.

With reference to the third aspect or any implementation of the third aspect, in a fourth implementation of the third aspect, the task controller is specifically configured to:

determine, according to the zone information, whether there exists a no-fly zone; and

if there exists a no-fly zone, determine a flight route that corresponds to the flight zone and avoids the no-fly zone.

With reference to the third aspect or any implementation of the third aspect, in a fifth implementation of the third aspect, the task controller is further configured to:

obtain flight state information after determining the first route task corresponding to the flight zone according to the zone information; and

determine, according to the flight state information, whether the first route task meets a first execution condition; and

the flight controller is specifically configured to:

execute the first route task in the flight zone if the first route task meets the first execution condition.

With reference to the fifth implementation of the third aspect, in a sixth implementation of the third aspect, the task controller is further configured to:

send first prompt information to the ground station by using the communications interface if the first route task does not meet the first execution condition, so as to indicate that execution of the first route task fails.

With reference to the third aspect, the first implementation of the third aspect, the second implementation of the third aspect, the third implementation of the third aspect, the fourth implementation of the third aspect, the fifth implementation of the third aspect, or the sixth implementation of the third aspect, in a seventh implementation of the third aspect, the task controller is further configured to:

in the process of executing the first route task, determine whether there exists a task that fails in execution; and

if there exists a task that fails in execution, after executing the first route task, determine a second route task according to location information corresponding to the task that fails in execution.

With reference to the seventh implementation of the third aspect, in an eighth implementation of the third aspect, the task controller is further configured to:

send a task execution failure message to the ground station by using the communications interface if there exists a task that fails in execution.

With reference to the eighth implementation of the third aspect, in a ninth implementation of the third aspect, the task controller is further configured to: receive, by using the communications interface, a control instruction that is sent by the ground station with respect to the second route task, and send the control instruction to the flight controller; and

the flight controller is further configured to execute the second route task according to the control instruction.

With reference to the third aspect, the first implementation of the third aspect, the second implementation of the third aspect, the third implementation of the third aspect, the fourth implementation of the third aspect, the fifth implementation of the third aspect, or the sixth implementation of the third aspect, in a tenth implementation of the third aspect, the communications interface is further configured to: receive updated route description information sent by the ground station, and send the updated route description information to the task controller, where the updated route description information includes updated waypoint information or updated zone information; and

the task controller is further configured to update the first route task to be a third route task according to the updated route description information.

With reference to the tenth implementation of the third aspect, in an eleventh implementation of the tenth implementation, the task controller is further configured to:

determine, according to a current execution state of the first route task, whether the third route task meets a second execution condition; and

execute the third route task by using the flight controller if the third route task meets the second execution condition;

send second prompt information to the ground station by using the communications interface if the third route task does not meet the second execution condition, so as to indicate that execution of the third route task fails.

According to a fourth aspect, the present application provides a ground station, including: a processor and a transmitter, the processor and the transmitter being connected, where

the processor is configured to generate zone information according to a user operation, where the zone information includes location information of a flight zone; and

the transmitter is configured to send route description information including the zone information to a UAV, so that the UAV determines a first route task corresponding to the flight zone according to the zone information.

With reference to the fourth aspect, in a first implementation of the fourth aspect, the ground station further includes a display interface, the display interface being connected to the processor, where

the processor is further configured to determine the first route task corresponding to the flight zone according to the zone information, and send the first route task to the display interface;

the display interface is configured to display the first route task; and

the processor is specifically configured to:

send the route description information including the zone information to the UAV by using the transmitter if a confirm operation of a user for the flight route is detected.

With reference to the first implementation of the fourth aspect, in a second implementation of the fourth aspect, the processor is further configured to: if a task execution failure message fed back by the UAV with respect to the first route task is received, determine a task that fails in execution in the first route task; and re-determine a second route task according to the task that fails in execution, and send the second route task to the display interface; and

the display interface is further configured to display the second route task.

With reference to the second implementation of the fourth aspect, in a third implementation of the fourth aspect, the processor is further configured to:

if a confirm operation of the user for the second route task is detected, send a control instruction to the UAV by using the transmitter, so that the UAV executes the second route task after receiving the control instruction.

With reference to the fourth aspect or the first implementation of the fourth aspect, in a fourth implementation of the fourth aspect, the ground station further includes: a user interface, the user interface being connected to the processor, where

the user interface is configured to receive an update operation of the user for the first route task, and send the update operation to the processor;

the processor is further configured to generate updated route description information according to the update operation, where the updated route description information includes updated waypoint information or updated zone information; and

the transmitter is further configured to send the updated route description information to the UAV, so that the UAV updates the first route task to be a third route task according to the updated route description information.

According to a fifth aspect, the present application provides a route information transmission apparatus, applied to a UAV, including:

a first receiving module, configured to receive route description information sent by a ground station, where the route description information includes zone information, and the zone information includes location information of a flight zone;

a first determining module, configured to determine a first route task corresponding to the flight zone according to the zone information; and

a first execution module, configured to execute the first route task in the flight zone.

With reference to the fifth aspect, in a first implementation of the fifth aspect, the first determining module includes:

a first determining sub-module, configured to determine location information of a start waypoint and a route shape according to the zone information; and

a second determining sub-module, configured to determine a flight route in the first route task according to the location information of the start waypoint and the route shape.

With reference to the fifth aspect, in a second implementation of the fifth aspect, the first determining module includes:

a third determining sub-module, configured to determine waypoint information in the flight zone according to the zone information; and

a fourth determining sub-module, configured to determine a flight route in the first route task according to the waypoint information.

With reference to the second implementation of the fifth aspect, in a third implementation of the fifth aspect, the third determining sub-module is specifically configured to:

determine, according to the zone information, location information of a start waypoint and location information of a terminal waypoint in the flight zone.

With reference to the fifth aspect or any implementation of the fifth aspect, in a fourth implementation of the fifth aspect, the first determining module includes:

a fifth determining sub-module, configured to determine, according to the zone information, whether there exists a no-fly zone; and

a sixth determining sub-module, configured to: if there exists a no-fly zone, determine a flight route that corresponds to the flight zone and avoids the no-fly zone.

With reference to the fifth aspect or any implementation of the fifth aspect, in a fifth implementation of the fifth aspect, the apparatus further includes:

an obtaining module, configured to obtain flight state information after the first determining module determines the first route task corresponding to the flight zone according to the zone information; and

a second determining module, configured to determine, according to the flight state information, whether the first route task meets a first execution condition;

where the first execution module is specifically configured to:

execute the first route task in the flight zone if the first route task meets the first execution condition.

With reference to the fifth implementation of the fifth aspect, in a sixth implementation of the fifth aspect, the apparatus further includes:

a first sending module, configured to send first prompt information to the ground station if the first route task does not meet the first execution condition, so as to indicate that execution of the first route task fails.

With reference to the fifth aspect, the first implementation of the fifth aspect, the second implementation of the fifth aspect, the third implementation of the fifth aspect, the fourth implementation of the fifth aspect, the fifth implementation of the fifth aspect, or the sixth implementation of the fifth aspect, in a seventh implementation of the fifth aspect, the apparatus further includes:

a first judgment module, configured to: in the process of executing the first route task, determine whether there exists a task that fails in execution; and

a third determining module, configured to: if there exists a task that fails in execution, after the first route task is executed, determine a second route task according to location information corresponding to the task that fails in execution.

With reference to the seventh implementation of the fifth aspect, in an eighth implementation of the fifth aspect, the apparatus further includes:

a second sending module, configured to send a task execution failure message to the ground station if there exists a task that fails in execution.

With reference to the eighth implementation of the fifth aspect, in a ninth implementation of the fifth aspect, the apparatus further includes:

a second receiving module, configured to receive a control instruction that is sent by the ground station with respect to the second route task; and

a second execution module, configured to execute the second route task according to the control instruction.

With reference to the fifth aspect, the first implementation of the fifth aspect, the second implementation of the fifth aspect, the third implementation of the fifth aspect, the fourth implementation of the fifth aspect, the fifth implementation of the fifth aspect, or the sixth implementation of the fifth aspect, in a tenth implementation of the fifth aspect, the apparatus further includes:

a third receiving module, configured to receive updated route description information sent by the ground station, where the updated route description information includes updated waypoint information or updated zone information; and

an update module, configured to update the first route task to be a third route task according to the updated route description information.

With reference to the tenth implementation of the fifth aspect, in an eleventh implementation of the fifth aspect, the apparatus further includes:

a second judgment module, configured to determine, according to a current execution state of the first route task, whether the third route task meets a second execution condition;

a third execution module, configured to execute the third route task if the third route task meets the second execution condition; and

a third sending module, configured to send second prompt information to the ground station if the third route task does not meet the second execution condition, so as to indicate that execution of the third route task fails.

According to a sixth aspect, the present application provides a route information transmission apparatus, applied to a ground station, including:

a first generation module, configured to generate zone information according to a user operation, where the zone information includes location information of a flight zone; and

a first sending module, configured to send route description information including the zone information to a UAV, so that the UAV determines a first route task corresponding to the flight zone according to the zone information.

With reference to the sixth aspect, in a first implementation of the sixth aspect, the apparatus further includes:

a first determining module, configured to determine the first route task corresponding to the flight zone according to the zone information; and

a first display module, configured to display the first route task;

where the first sending module is specifically configured to:

send the route description information including the zone information to the UAV if a confirm operation of a user for the flight route is detected.

With reference to the sixth aspect or the first implementation of the sixth aspect, in a second implementation of the sixth aspect, the apparatus further includes:

a second determining module, configured to: if a task execution failure message fed back by the UAV with respect to the first route task is received, determine a task that fails in execution in the first route task;

a third determining module, configured to re-determine a second route task according to the task that fails in execution; and

a second display module, configured to display the second route task.

With reference to the second implementation of the sixth aspect, in a third implementation of the sixth aspect, the apparatus further includes:

a second sending module, configured to: if a confirm operation of the user for the second route task is detected, send a control instruction to the UAV, so that the UAV executes the second route task after receiving the control instruction.

With reference to the sixth aspect or the first implementation of the sixth aspect, in a fourth implementation of the sixth aspect, the apparatus further includes:

a receiving module, configured to receive an update operation of the user for the first route task;

a second generation module, configured to generate updated route description information according to the update operation, where the updated route description information includes updated waypoint information or updated zone information; and

a third sending module, configured to send the updated route description information to the UAV, so that the UAV updates the first route task to be a third route task according to the updated route description information.

According to a seventh aspect, the present application provides a UAV, including units or means configured to perform steps of any method in the first aspect.

According to an eighth aspect, the present application provides a UAV, including at least one processing element or chip configured to perform any method in the first aspect.

According to a ninth aspect, the present application provides a program, where the program is configured to execute any method in the first aspect when being executed by a controller.

According to a tenth aspect, the present application provides a computer readable storage medium, including the program in the ninth aspect.

According to an eleventh aspect, the present application provides a ground station, including units or means configured to perform steps of any method in the first aspect.

According to a twelfth aspect, the present application provides a ground station, including at least one processing element or chip configured to perform any method in the first aspect.

According to a thirteenth aspect, the present application provides a program, where the program is configured to execute any method in the first aspect when being executed by a processor.

According to a fourteenth aspect, the present application provides a computer readable storage medium, including the program in the thirteenth aspect.

According to a fifteenth aspect, the present application provides a route information transmission system, including the UAV in the third aspect and the ground station in the fourth aspect.

The present application achieves the following technical effect: route description information sent by a ground station is received, where the route description information includes zone information, and the zone information includes location information of a flight zone; a first route task corresponding to the flight zone is determined according to the zone information; and the first route task is executed in the flight zone. Zone information required for flight is sent to a UAV, so that the UAV can generate a flight route according to the zone information. Therefore, a ground station no longer needs to send complete route information to the UAV; instead, the UAV generates the flight route automatically and then obtains a route task. As such, the data amount of information transmitted between the ground station and the UAV can be reduced, thereby improving transmission efficiency of the information and improving route execution efficiency of the UAV.

### BRIEF DESCRIPTION OF THE DRAWINGS

FIG. 1 is a schematic flowchart of a route information transmission method according to an embodiment of the present application;

FIG. 2 is a signaling diagram of a route information transmission method according to an embodiment of the present application;

FIG. 3 is a signaling diagram of another route information transmission method according to an embodiment of the present application;

FIG. 4 is a signaling diagram of still another route information transmission method according to an embodiment of the present application;

FIG. 5 is a signaling diagram of yet another route information transmission method according to an embodiment of the present application;

FIG. 6 is a signaling diagram of further another route information transmission method according to an embodiment of the present application;

FIG. 7 is a signaling diagram of further another route information transmission method according to an embodiment of the present application;

FIG. 8 is a signaling diagram of further another route information transmission method according to an embodiment of the present application;

FIG. 9 is a schematic flowchart of further another route information transmission method according to an embodiment of the present application;

FIG. 10 is a first schematic diagram of an interface display of a ground station according to an embodiment of the present application;

FIG. 11 is a second schematic diagram of an interface display of a ground station according to an embodiment of the present application;

FIG. 12 is a signaling diagram of further another route information transmission method according to an embodiment of the present application;

FIG. 13 is a signaling diagram of further another route information transmission method according to an embodiment of the present application;

FIG. 14 is a third schematic diagram of an interface display of a ground station according to an embodiment of the present application;

FIG. 15 is a fourth schematic diagram of an interface display of a ground station according to an embodiment of the present application;

FIG. 16 is a fifth schematic diagram of an interface display of a ground station according to an embodiment of the present application;

FIG. 17 is a signaling diagram of further another route information transmission method according to an embodiment of the present application;

FIG. 18 is a sixth schematic diagram of an interface display of a ground station according to an embodiment of the present application;

FIG. 19 is a seventh schematic diagram of an interface display of a ground station according to an embodiment of the present application;

FIG. 20 is a signaling diagram of further another route information transmission method according to an embodiment of the present application;

FIG. 21 is an eighth schematic diagram of an interface display of a ground station according to an embodiment of the present application;

FIG. 22 is a schematic structural diagram of a UAV according to an embodiment of the present application;

FIG. 23 is a schematic structural diagram of a ground station according to an embodiment of the present application;

FIG. 24 is a schematic structural diagram of another ground station according to an embodiment of the present application;

FIG. 25 is a schematic structural diagram of a route information transmission apparatus according to an embodiment of the present application;

FIG. 26 is a schematic structural diagram of another route information transmission apparatus according to an embodiment of the present application;

FIG. 27 is a schematic structural diagram of still another route information transmission apparatus according to an embodiment of the present application;

FIG. 28 is a schematic structural diagram of yet another route information transmission apparatus according to an embodiment of the present application;

FIG. 29 is a schematic structural diagram of further another route information transmission apparatus according to an embodiment of the present application;

FIG. 30 is a schematic structural diagram of further another route information transmission apparatus according to an embodiment of the present application;

FIG. 31 is a schematic structural diagram of further another route information transmission apparatus according to an embodiment of the present application;

FIG. 32 is a schematic structural diagram of further another route information transmission apparatus according to an embodiment of the present application;

FIG. 33 is a schematic structural diagram of further another route information transmission apparatus according to an embodiment of the present application; and

FIG. 34 is a schematic structural diagram of further another route information transmission apparatus according to an embodiment of the present application.

### DETAILED DESCRIPTION

Exemplary embodiments will be described in detail herein, and are schematically shown in the accompanying drawings. When the following description relates to the accompanying drawings, identical numerals in different drawings represent identical or similar elements unless otherwise specified. Implementations described in the following exemplary embodiments do not represent all implementations consistent with the present application. On the contrary, the implementations are merely examples of apparatuses and methods consistent with some aspects of the present application as described in the claims in detail.

The embodiments of the present application are applied to a UAV or in an aircraft that may appear in the future. Some terms in the present application are illustrated to help a person skilled in the art understand the teens. It should be noted that, when the solutions of the embodiments of the present application are applied to a UAV or in an aircraft that may appear in the future, names of the ground station, UAV, flight controller, and task controller may change, but the change does not affect the implementation of the solutions of the embodiments of the present application.

The technical solutions of the embodiments of the present application are described below with reference to the accompanying drawings.

First, technical terms involved in the present application are illustrated:

1) A ground station may also be referred to as a ground control device or a remote controller. The ground station may send information or a control command to a UAV, and may also receive flight data, images, and other information fed back by the UAV. The ground station may include a remote control, or a user terminal, or a device integrating functions of a remote control and a user terminal. An application program related to the UAV may be installed in the user terminal. The user terminal can be connected to the remote control of the UAV by running the application program. Moreover, the user terminal may send a control instruction to the UAV by using the remote control, or receive, by using the remote control, images, flight data, or the like fed back by the UAV. In addition, the user terminal can display images or flight data. Alternatively, the user terminal can communicate with the UAV directly.

2) A flight controller, also referred to as a flight control system, is a control device on a UAV, and is configured to control a power system of the UAV, so as to control flight of the UAV.

3) A task controller may also be referred to as a task control unit or a task management controller. The task controller is a hardware apparatus added to a UAV in the present application, and is configured to process information sent by the ground station to the UAV, process information sent by the UAV to the ground station, and so on.

4) The term “multiple” means two or more than two, and this also applies to other quantifiers.

It should be noted that, for nouns and terms involved in the embodiments of the present application, reference may be made to each other, and details are not described again.

With advantages such as a small size, a UAV can go to many areas to complete aerial photographing, news reporting, surveying and mapping, and the like. Route information is stored in the UAV. The route information includes waypoint information of multiple waypoints, and the waypoint information of each waypoint includes geographical location information of the waypoint, and so on. Therefore, the UAV can complete flight according to the route information. However, if the control device on the ground sends all information of the entire route to the UAV during the flight process of the UAV, communication between the control device and the UAV will be slow. As a result, the UAV cannot receive the information of the entire route in time, hindering the flight of the UAV.

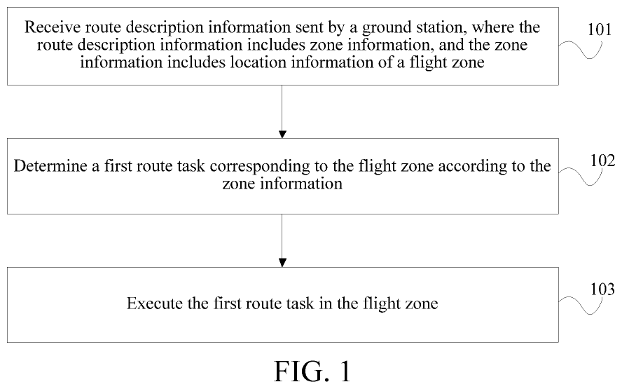

FIG. 1 is a schematic flowchart of a route information transmission method according to an embodiment of the present application. As shown in FIG. 1, the method can be applied to a UAV, and includes the following steps:

S101: Receive route description information sent by a ground station, where the route description information includes zone information, and the zone information includes location information of a flight zone

For example, the ground station sends route description information to the UAV, where the route description information includes zone information, and each piece of zone information carries location information of a flight zone. Therefore, a communications interface of the UAV can receive the route description information sent by the ground station. Then, the communications interface of the UAV sends the received route description information to a task controller of the UAV, or the task controller of the UAV automatically obtains the route description information received by the communications interface.

Optionally, the route description information includes one piece of zone information; or the route description information includes multiple pieces of zone information; or the route description information includes one or more pieces of zone information, and the route description information further includes one or more pieces of waypoint information.

For example, the route description information includes zone information of a flight zone 1, and the zone information of the flight zone 1 includes a name of the flight zone 1, location information of the flight zone 1, a flight task of the flight zone 1, and the like.

For another example, the route description information includes zone information of a flight zone 1, zone information of a flight zone 2, and zone information of a flight zone 3; the zone information of the flight zone 1 includes a name of the flight zone 1, location information of the flight zone 1, and a flight task of the flight zone 1; the zone information of the flight zone 2 includes a name of the flight zone 2, location information of the flight zone 2, and a flight task of the flight zone 2; the zone information of the flight zone 3 includes a name of the flight zone 3, location information of the flight zone 3, and a flight task of the flight zone 3.

For still another example, the route description information includes zone information of a flight zone 1, zone information of a flight zone 2, and route information of a waypoint 1.

Optionally, the location information of the flight zone may include a longitude range, a latitude range, and a height range of the flight zone. The location information of the waypoint may include the longitude, the latitude, and the height of the waypoint.

S102: Determine a first route task corresponding to the flight zone according to the zone information.

For example, the task controller of the UAV needs to generate a first route task. Specifically, the task controller generates the first route task according to the location information of the flight zone in the received zone information and a flight task. The flight task refers to other tasks in addition to the flight, for example, aerial photographing, news reporting, and surveying and mapping. The flight task may be sent by the ground station to the task controller of the UAV, or the flight task is pre-stored in the task controller of the UAV.

For example, the route description information includes zone information of a flight zone 1, zone information of a flight zone 2, and zone information of a flight zone 3; the task controller determines, according to location information in the foregoing zone information, a flight route that passes the flight zone 1, the flight zone 2 and the flight zone 3 and a flight task that the UAV needs to execute in each flight zone, thereby obtaining the first route task. Herein, the flight task refers to a task implemented by the UAV using an apparatus having functions except flight. For example, the UAV executes a photographing task by using a carried camera, or the UAV executes a spreading task, such as spreading liquid or gas, by using a carried spreading apparatus. The flight task is not limited in this embodiment of the present application.

Then, the task controller sends the determined first route task to a flight controller of the UAV.

S103: Execute the first route task in the flight zone.

For example, the flight controller is a device in the UAV for controlling flight of the UAV. After receiving the first route task, the flight controller can control the UAV. For example, by controlling a power system of the UAV, the flight controller controls the UAV to fly according to the first route task. Moreover, the flight controller needs to control a flight route along which the UAV flies and the flight task of the UAV to be consistent with the first route task.

For example, when the UAV starts to fly, the ground station sends initial route information to the UAV, where the route information consists of one or more pieces of zone information. Optionally, the route information may further include waypoint information. Therefore, the ground station does not need to send a complete route task to the UAV; instead, the UAV generates the route task automatically. The data amount of information transmitted between the ground station and the UAV is reduced, thereby improving transmission efficiency of the initial route information.

For another example, in the flight process of the UAV, the ground station needs to send updated route information to the UAV; the ground station only changes the zone information or the waypoint information, and sends the changed zone information or waypoint information to the UAV, rather than sending all zone information and waypoint information in the updated route information to the UAV. Therefore, the amount of data received by the UAV is reduced, thereby improving transmission efficiency of the updated route information, and improving route execution efficiency of the UAV.

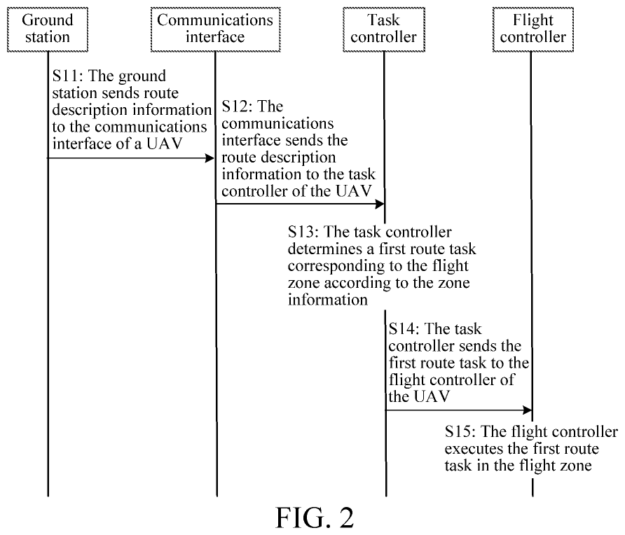

FIG. 2 is a signaling diagram of a route information transmission method according to an embodiment of the present application. FIG. 2 is used for executing the process of the route information transmission method provided in FIG. 1. As shown in FIG. 2, the method includes the following steps:

S11: A ground station sends route description information to a communications interface of a UAV, where the route description information includes zone information, and the zone information includes location information of a flight zone.

For example, for this step, reference can be made to step S101 in FIG. 1. Details are not described again.

S12: The communications interface sends the route description information to a task controller of the UAV.

S13: The task controller determines a first route task corresponding to the flight zone according to the zone information.

For example, for this step, reference can be made to step S102 in FIG. 1. Details are not described again.

S14: The task controller sends the first route task to a flight controller of the UAV.

S15: The flight controller executes the first route task in the flight zone.

For example, for this step, reference can be made to step S103 in FIG. 1. Details are not described again.

In this embodiment, route description information sent by a ground station is received, where the route description information includes zone information, and the zone information includes location information of a flight zone; a first route task corresponding to the flight zone is determined according to the zone information; and the first route task is executed in the flight zone. Zone information required for flight is sent to the UAV, so that the UAV can generate a flight route according to the zone information. Therefore, the ground station no longer needs to send complete route information to the UAV; instead, the UAV generates the flight route automatically and then obtains a route task. As such, the data amount of information transmitted between the ground station and the UAV can be reduced, thereby improving transmission efficiency of the information and improving route execution efficiency of the UAV.

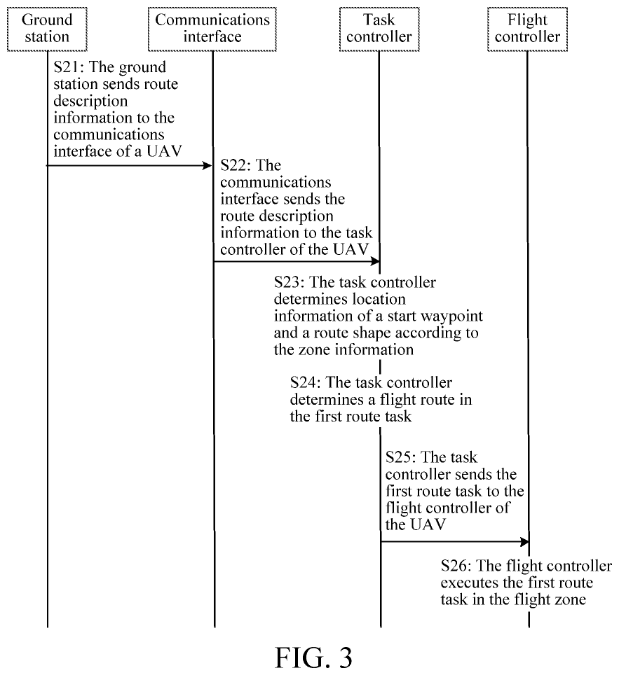

FIG. 3 is a signaling diagram of another route information transmission method according to an embodiment of the present application. As shown in FIG. 3, the method includes the following steps:

S21: A ground station sends route description information to a communications interface of a UAV, where the route description information includes zone information, and the zone information includes location information of a flight zone.

For example, the ground station sends route description information to the UAV, where the route description information includes one or more pieces of zone information. Each piece of zone information includes location information of a corresponding flight zone.

The zone information corresponds to flight zones in a one-to-one manner. For example, the route description information includes two pieces of zone information, which are zone information 1 and zone information 2 respectively, where the zone information 1 corresponds to a flight zone 1, and the zone information 2 corresponds to a flight zone 2. The zone information 1 includes location information of the flight zone 1, and the zone information 2 includes location information of the flight zone 2.

Moreover, each piece of zone information carries route shape information of a corresponding flight zone, or each piece of zone information carries location information of a start waypoint of a corresponding flight zone, or each piece of zone information carries route shape information of a corresponding flight zone and location information of a start waypoint.

Optionally, the route description information further includes one or more pieces of waypoint information.

S22: The communications interface sends the route description information to a task controller of the UAV.

S23: The task controller determines location information of a start waypoint and a route shape according to the zone information.

For example, each piece of zone information includes location information of a corresponding flight zone. The task controller can randomly determine location information of a start waypoint corresponding to each piece of zone information. Then, the task controller generates, according to the location information of the start waypoint corresponding to each piece of zone information, a route shape of the flight zone corresponding to each piece of zone information by using a route generating algorithm.

Alternatively, each piece of zone information includes location information of a corresponding flight zone, and moreover, each piece of zone information includes route shape information of the corresponding flight zone. The task controller can randomly determine location information of a start waypoint corresponding to each piece of zone information. Moreover, the task controller can parse out the route shape information included in each piece of zone information. Then, the task controller generates a route shape of the flight zone corresponding to each piece of zone information according to the route shape information parsed out from each piece of zone information.

Alternatively, each piece of zone information includes location information of a corresponding flight zone, and moreover, each piece of zone information carries location information of a start waypoint of the corresponding flight zone. The task controller parses out the location information of the start waypoint included in each piece of zone information.

The task controller generates, according to the location information of the start waypoint corresponding to each piece of zone information, a route shape of the flight zone corresponding to each piece of zone information by using a route generating algorithm.

Alternatively, each piece of zone information includes location information of a corresponding flight zone, and moreover, each piece of zone information carries route shape information of the corresponding flight zone and location information of a start waypoint. The task controller parses out the route shape information and the location information of the start waypoint that are included in each piece of zone information. The task controller generates a route shape of the flight zone corresponding to each piece of zone information according to the route shape information parsed out from each piece of zone information.

Then, the task controller generates a route shape in the first route task according to the route shape of the flight zone corresponding to each piece of zone information, or the task controller determines, according to each piece of zone information, a route of the flight zone corresponding to each piece of zone information during flight.

For example, the task controller receives zone information 1 and zone information 2. The task controller can determine a flight zone 1 corresponding to the zone information 1, and determine location information of a start waypoint 1 in the flight zone 1 as well as a route shape of the UAV in the flight zone 1. The task controller can determine a flight zone 2 corresponding to the zone information 2, and determine location information of a start waypoint 2 in the flight zone 2 as well as a route shape of the UAV in the flight zone 2. Further, the task controller constructs a flight route of the first route task according to the determined flight zone 1 and flight zone 2, so that the flight route can pass the flight zone 1 and the flight zone 2. Further, the task controller can determine a route shape of the flight route of the first route task based on the route shapes of the flight zone 1 and the flight zone 2.

Therefore, when executing the first route task, the UAV can fly to the flight zone 1 according to the flight route in the first route task, and fly in the flight zone 1 according to the route shape of the flight zone 1. Further, in the flight zone 1, the UAV can execute a flight task corresponding to the flight zone 1. Then, the UAV flies to the flight zone 2 according to the flight route in the first route task, and flies in the flight zone 2 according to the route shape of the flight zone 2. Further, in the flight zone 2, the UAV can execute a flight task corresponding to the flight zone 2.

S24: The task controller determines a flight route in the first route task according to the location information of the start waypoint and the route shape.

For example, the task controller can determine a flight direction in the first route task according to the location information of the start waypoint corresponding to each piece of zone information and the route shape in the first route task, and then determine a flight route in the first route task. Moreover, the task controller can determine the first route task according to the flight route and flight task in the first route task.

The flight route represents a route along which the UAV flies. The flight task represents other tasks, such as aerial photographing, news reporting, and surveying and mapping, which the UAV needs to execute when flying on the flight route.

S25: The task controller sends the first route task to a flight controller of the UAV.

S26: The flight controller executes the first route task in the flight zone.

For example, for this step, reference can be made to step S103 in FIG. 1. Details are not described again.

In this embodiment, zone information sent by a ground station is received; location information of a start waypoint and a route shape are determined according to the zone information; then a flight route in a first route task is generated, and the first route task is therefore determined. As such, the UAV can generate the flight route and the first route task according to the zone information. The ground station no longer needs to send a complete route task to the UAV; instead, the UAV generates the flight route automatically and then generates the route task. As such, the data amount of information transmitted between the ground station and the UAV can be reduced, thereby improving transmission efficiency of the information and improving route execution efficiency of the UAV.

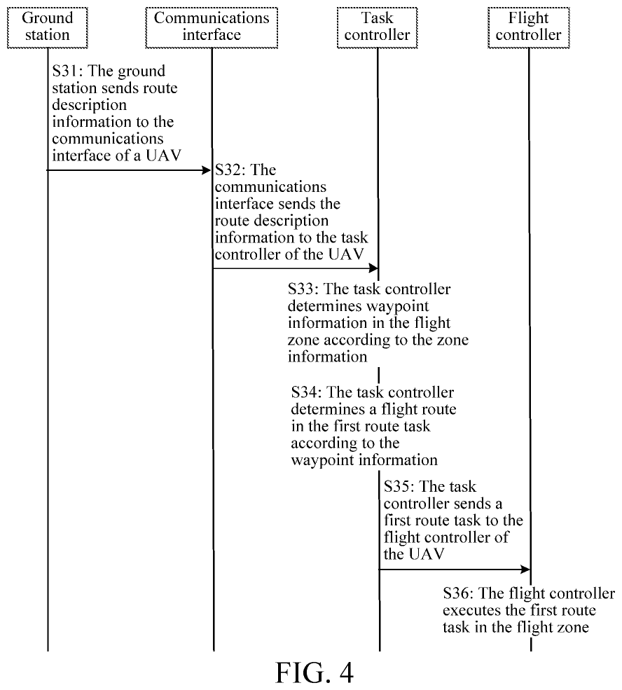

FIG. 4 is a signaling diagram of still another route information transmission method according to an embodiment of the present application. As shown in FIG. 4, the method includes the following steps:

S31: A ground station sends route description information to a communications interface of a UAV, where the route description information includes zone information, and the zone information includes location information of a flight zone.

For example, the ground station sends route description information to the UAV, where the route description information includes one or more pieces of zone information. Each piece of zone information includes location information of a corresponding flight zone.

The zone information corresponds to flight zones in a one-to-one manner. For example, the route description information includes two pieces of zone information, which are zone information 1 and zone information 2 respectively, where the zone information 1 corresponds to a flight zone 1, and the zone information 2 corresponds to a flight zone 2. The zone information 1 includes location information of the flight zone 1, and the zone information 2 includes location information of the flight zone 2.

S32: The communications interface sends the route description infon ration to a task controller of the UAV.

S33: The task controller determines waypoint information in the flight zone according to the zone information.

In an optional implementation, step S33 specifically includes: determining, according to the zone information, location information of a start waypoint and location information of a terminal waypoint in the flight zone.

For example, the task controller may determine a flight zone corresponding to each piece of zone information according to each piece of zone information, and determine waypoint information in each flight zone. For example, the task controller determines, according to location information of a flight zone 1 in zone information 1, that the zone information 1 corresponds to the flight zone 1, and then the task controller determines waypoint information 1, waypoint information 2 and waypoint information 3 in the flight zone 1. The task controller can determine, according to the waypoint information in the flight zone, a route in the flight zone.

Optionally, the zone information indicates location information of a start waypoint and location information of a terminal waypoint in the flight zone. According to the location information of the start waypoint and the location information of the terminal waypoint in each flight zone, the task controller generates waypoint information in each flight zone by using a waypoint generating algorithm. For example, the zone information further indicates an association relation between waypoint information. Then, the task controller can calculate waypoint information in each flight zone according to the location information of the start waypoint and the location information of the terminal waypoint in each flight zone as well as the association relation between waypoint information in each flight zone.

Alternatively, the task controller may randomly determine location information of a start waypoint and location information of a terminal waypoint in each flight zone. Then, according to the location information of the start waypoint and the location information of the terminal waypoint in each flight zone, the task controller may calculate waypoint information in each flight zone by using a waypoint generating algorithm.

Alternatively, the task controller may calculate, according to the location information of the flight zone in each piece of zone information, waypoint information in each flight zone by using a waypoint generating algorithm. For example, the task controller may randomly determine waypoint information in each flight zone.

Alternatively, each piece of zone information includes one or more pieces of waypoint information. The task controller may calculate an association relation between waypoint information in each piece of zone information according to the waypoint information in each piece of zone information, and then calculate all waypoint information in each piece of zone information.

Alternatively, each piece of zone information includes one or more pieces of waypoint information, and moreover, each piece of zone information includes an association relation between waypoint information. The task controller calculates all waypoint information in each piece of zone information according to the waypoint information in each piece of zone information as well as the association relation between waypoint information in each piece of zone information.

Alternatively, each piece of zone information includes one or more pieces of waypoint information, and moreover, each piece of zone information indicates an association relation between waypoint information. The task controller calculates all waypoint information in each piece of zone information according to the waypoint information in each piece of zone information as well as the association relation between waypoint information in each piece of zone information. The association relation between waypoint information refers to an order relation between waypoint information. For example, the association relation between waypoint information is: waypoint information 1—waypoint information 3—waypoint information 2. Then, the association relation represents that the UAV needs to fly to the location represented by the waypoint information 1 first, then fly to the location represented by the waypoint information 3, and finally fly to the location represented by the waypoint information 2.

S34: The task controller determines a flight route in the first route task according to the waypoint information.

For example, the task controller determines a route shape and a flight direction of the UAV in each flight zone according to the waypoint information of each flight zone. The task controller generates a flight route according to the route shape and the flight direction of the UAV in each flight zone. The task controller generates the first route task according to the flight route and the flight task. The flight task refers to other tasks except the flight, such as aerial photographing, news reporting, and surveying and mapping; the flight task may be sent by the ground station to the task controller of the UAV, or the flight task is pre-stored in the task controller of the UAV.

For example, the task controller receives zone information 1, zone information 2 and zone information 3. The task controller may determine that the zone information 1 corresponds to waypoint information 1 and waypoint information 2, the zone information 2 corresponds to waypoint information 3 and waypoint information 4, and the zone information 3 corresponds to waypoint information 5, waypoint information 6 and waypoint information 7. The zone information 1 corresponds to a flight zone 1, the zone information 2 corresponds to a flight zone 2, and the zone information 3 corresponds to a flight zone 3. The task controller determines that an association relation between waypoint information in the flight zone 1 is waypoint information 1—waypoint information 2, an association relation between waypoint information in the flight zone 2 is waypoint information 4—waypoint information 3, and an association relation between waypoint information in the flight zone 3 is waypoint information 5—waypoint information 7—waypoint information 6. Therefore, the task controller can determine a route shape of the UAV in the flight zone 1 according to waypoint information 1—waypoint information 2, and can determine a flight direction and location information of a start waypoint in the flight zone 1. For example, the task controller randomly determines a flight direction and location information of a start waypoint. For another example, the task controller receives a flight direction and location information of a start waypoint that are sent by the ground station. Moreover, the task controller can determine a route shape of the UAV in the flight zone 2 according to waypoint information 4—waypoint information 3, and determine a flight direction and location information of a start waypoint in the flight zone 2. The task controller can determine a route shape of the UAV in the flight zone 2 according to waypoint information 5—waypoint information 7—waypoint information 6, and determine a flight direction and location information of a start waypoint in the flight zone 3. The task controller can obtain a flight route by combining the route shapes, the flight directions, and the location information of the start waypoints in all the flight zones. Then, the task controller generates the first route task according to the flight route and the flight task.

S35: The task controller sends a first route task to a flight controller of the UAV.

S36: The flight controller executes the first route task in the flight zone.

For example, for this step, reference can be made to step S103 in FIG. 1. Details are not described again.

In this embodiment, zone information sent by a ground station is received; waypoint information in a flight zone is determined according to the zone information; then, a flight route in a first route task is generated; and the first route task is therefore determined. As such, the UAV can generate the flight route and the first route task according to the zone information. The ground station no longer needs to send a complete route task to the UAV; instead, the UAV generates the flight route automatically and then generates the route task. As such, the data amount of information transmitted between the ground station and the UAV can be reduced, thereby improving transmission efficiency of the information and improving route execution efficiency of the UAV.

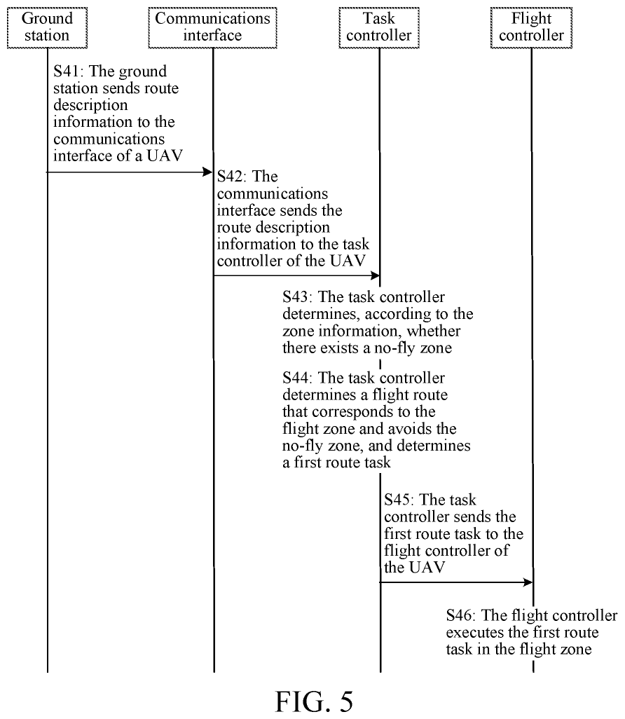

FIG. 5 is a signaling diagram of yet another route information transmission method according to an embodiment of the present application. As shown in FIG. 5, the method includes the following steps:

S41: A ground station sends route description information to a communications interface of a UAV, where the route description information includes zone information, and the zone information includes location information of a flight zone.

For example, for this step, reference can be made to step S11 in FIG. 2, or step S21 in FIG. 3, or step S31 in FIG. 4. Details are not described again.

S42: The communications interface sends the route description information to a task controller of the UAV.

S43: The task controller determines, according to the zone information, whether there exists a no-fly zone.

For example, the zone information corresponds to flight zones in a one-to-one manner.

Each piece of zone information includes location information of a corresponding flight zone. Therefore, the task controller can obtain location information of each flight zone that a flight route needs to pass.

The task controller needs to determine whether there exists a no-fly zone in the flight zones. Optionally, location information of a no-fly zone is stored in the task controller, and the task controller compares the received location information of the flight zones with the location information of the no-fly zone, to determine whether the flight zones include the no-fly zone. Alternatively, the zone information indicates location information of a no-fly zone, so that the task controller compares the received location information of the flight zones with the location information of the no-fly zone, to determine whether the flight zones include the no-fly zone. Alternatively, the ground station sends location information of a no-fly zone to the task controller through the communications interface of the UAV in real time, and then the task controller compares the received location information of the flight zones with the received location information of the no-fly zone, to determine whether the flight zones include the no-fly zone.

Optionally, the ground station may add the location information of the no-fly zone to the route description information, and send the location information of the no-fly zone to the UAV. In this case, the task controller of the UAV may adjust a flight route in a first route task according to the location information of the no-fly zone after determining the first route task according to the route description information, so that the first route task avoids the no-fly zone. Alternatively, the task controller of the UAV determines a flight route of a first route task according to the location of the no-fly zone after determining a flight route in each flight zone, thereby avoiding the no-fly zone.

Optionally, the zone information sent by the ground station may include the location information of the no-fly zone. In this case, the task controller of the UAV determines, according to the location information of the no-fly zone, a flight route that already avoids the no-fly zone in the flight zone corresponding to the zone information, so that the first route task avoids the no-fly zone.

S44: If determining that there exists a no-fly zone, the task controller determines a flight route that corresponds to the flight zone and avoids the no-fly zone, and determines a first flight task.

For example, during determining of the first route task in steps S43-44, reference may also be made to step S13 in FIG. 2, or steps S23-S24 in FIG. 3, or steps S33-S34 in FIG. 4.

Moreover, when determining the first route task, if the task controller determines, according to the analysis and judgment in step S43, that there exists a no-fly zone in the flight zones, the task controller needs to exclude the no-fly zone from the flight route when generating the flight route, that is, the task controller determines a flight route that avoids the no-fly zone. Then, the task controller generates the first route task according to the flight route and the flight task.

For example, the task controller receives zone information 1, zone information 2 and zone information 3, where the zone information 1 corresponds to a flight zone 1, the zone information 2 corresponds to a flight zone 2, and the zone information 3 corresponds to a flight zone 3. In the process of generating the first route task, the task controller needs to determine whether there exists a no-fly zone in the flight zone 1, the flight zone 2, and the flight zone 3. If the task controller determines that the flight zone 1 is a no-fly zone, the task controller determines to avoid the flight zone 1 and determines that the flight route does not pass the flight zone 1.

S45: The task controller sends the first route task to a flight controller of the UAV.

S46: The flight controller executes the first route task in the flight zone.

For example, for this step, reference can be made to step S15 in FIG. 2, or step S25 in FIG. 3, or step S35 in FIG. 4. Details are not described again.

In this embodiment, when generating a flight route, the UAV can determine a no-fly zone, and further determine a flight route that avoids the no-fly zone. A method in which the UAV automatically avoids the no-fly zone is provided. The UAV can avoid the no-fly zone automatically without remote control of the ground station. The ground station no longer needs to send a no-fly indication to the UAV, reducing information transmitted between the ground station and the UAV.

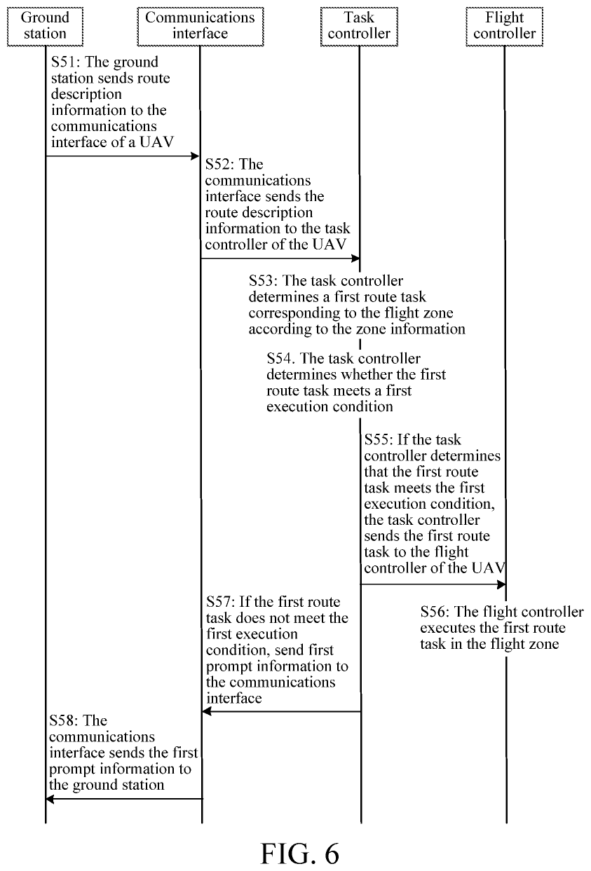

FIG. 6 is a signaling diagram of further another route information transmission method according to an embodiment of the present application. As shown in FIG. 6, the method includes the following steps:

S51: A ground station sends route description infatuation to a communications interface of a UAV, where the route description information includes zone information, and the zone information includes location information of a flight zone.

For example, for this step, reference can be made to step S11 in FIG. 2, or step S21 in FIG. 3, or step S31 in FIG. 4, or step S41 in FIG. 5. Details are not described again.

S52: The communications interface sends the route description information to a task controller of the UAV.

S53: The task controller determines a first route task corresponding to the flight zone according to the zone information.

For example, for this step, reference can be made to step S13 in FIG. 2, or steps S23-S24 in FIG. 3, or steps S33-S34 in FIG. 4, or steps S43-S44 in FIG. 5. Details are not described again.

S54. The task controller obtains flight state information, and determines, according to the flight state information, whether the first route task meets a first execution condition.

For example, if the UAV is in a flight state, the task controller needs to obtain flight state information, to determine whether the first route task meets a first execution condition. That is, the task controller determines, according to the flight state information, whether the first route task can be executed.

Optionally, the flight state information includes at least one of the following information: current location information of the UAV, heading and attitude information of the UAV, a battery capacity of the UAV, a current battery level of the UAV, current environment information of the UAV, and the like.

Optionally, the first execution condition includes at least one of the following information: preset route information, a preset flight environment, a preset flight task, preset state information, and the like.

Optionally, the preset route information includes preset location information and heading information of the UAV. The preset flight environment includes preset weather information and preset geographical information; the preset weather information includes a wind direction, temperature, humidity, and the like; the preset geographical information includes altitude, and the like. The preset flight task includes a preset aerial photographing task, a preset news reporting task, a preset surveying and mapping task, and the like. The preset state information includes a preset battery capacity.

For example, the task controller obtains the current battery level of the UAV. Then, the task controller determines a remaining journey according to the route information of the UAV. Then, the task controller determines whether the current battery level of the UAV can support the UAV to finish the remaining journey. If determining that the current battery level of the UAV can support the UAV to finish the remaining journey, the task controller determines that the first route task can be executed; if determining that the current battery level of the UAV cannot support the UAV to finish the remaining journey, the task controller determines that the first route task cannot be executed.

For another example, the task controller obtains the current environment information of the UAV, such as a current wind speed. Then, the task controller determines whether the current environment information of the UAV meets the preset flight environment. For example, the task controller determines whether the current wind speed meets a preset wind speed; if yes, the task controller determines that the first route task can be executed; otherwise, the task controller determines that the first route task cannot be executed.

For another example, the task controller obtains a current location of the UAV, and further determines whether a distance between the current location of the UAV and a location of a start waypoint of the first route task is less than a preset distance threshold; if yes, the task controller determines that the first route task can be executed; otherwise, the task controller determines that the first route task cannot be executed.

S55: If the task controller determines that the first route task meets the first execution condition, the task controller sends the first route task to a flight controller of the UAV.

For example, when determining that the first route task meets the first execution condition, the task controller sends the generated first route task to the flight controller, and then the flight controller completes step S56.

In another implementation, the task controller may send the first route task to the flight controller; the flight controller obtains the flight state information of the UAV, and determines, according to the obtained flight state information, whether the first route task can be executed, that is, whether the first route task meets the first execution condition.

S56: The flight controller executes the first route task in the flight zone.

For example, this step is performed after step S55. For this step, reference can be made to step S15 in FIG. 2, or step S25 in FIG. 3, or step S35 in FIG. 4, or step S45 in FIG. 5. Details are not described again.

S57: If the task controller determines that the first route task does not meet the first execution condition, the task controller sends first prompt information to the communications interface, to indicate that execution of the first route task fails.

S58: The communications interface sends the first prompt information to the ground station.

For example, after step S55, when the task controller determines that the first route task does not meet the first execution condition, the task controller sends first prompt information to the ground station through the communications interface, where the first prompt information represents that execution of the first route task fails, and the first prompt information also includes a cause of the execution failure.

In this embodiment, in the flight process of the UAV, the flight controller of the UAV may determine in real time, according to flight state information of the UAV, whether the first route task meets an execution condition, so that the task controller determines whether to execute the route task. As such, the task controller of the UAV completes the flight control process, while the ground station no longer needs to send a control command, thereby reducing information transmitted between the ground station and the UAV.

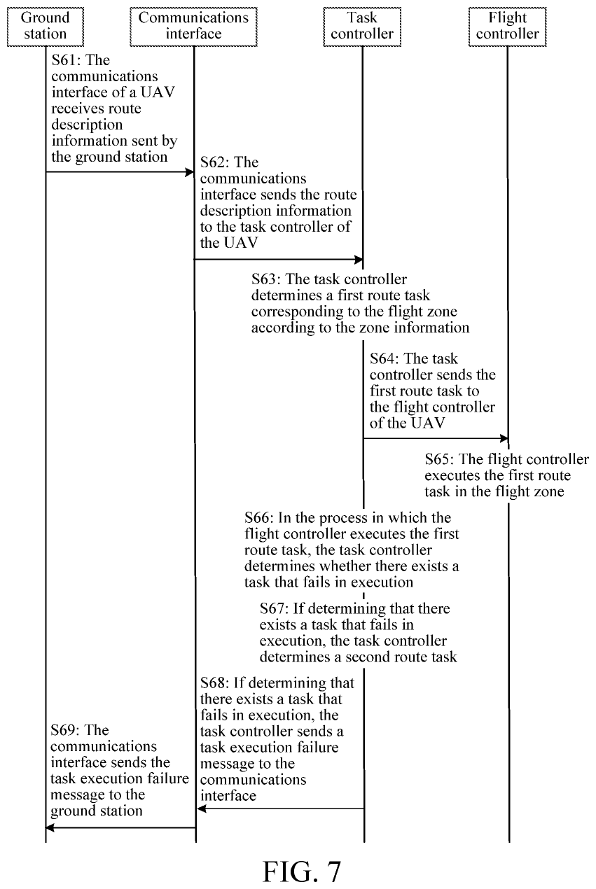

FIG. 7 is a signaling diagram of further another route information transmission method according to an embodiment of the present application. As shown in FIG. 7, the method includes the following steps:

S61: A communications interface of a UAV receives route description information sent by a ground station, where the route description information includes zone information, and the zone information includes location information of a flight zone.

For example, for this step, reference can be made to step S11 in FIG. 2, or step S21 in FIG. 3, or step S31 in FIG. 4, or step S41 in FIG. 5, or step S51 in FIG. 6. Details are not described again.

S62: The communications interface sends the route description information to a task controller of the UAV.

S63: The task controller determines a first route task corresponding to the flight zone according to the zone information.

For example, for this step, reference can be made to step S13 in FIG. 2, or steps S23-S24 in FIG. 3, or steps S33-S34 in FIG. 4, or steps S43-S44 in FIG. 5, or step S53 in FIG. 6. Details are not described again.

S64: The task controller sends the first route task to a flight controller of the UAV.

S65: The flight controller executes the first route task in the flight zone.

For example, for this step, reference can be made to step S15 in FIG. 2, or step S25 in FIG. 3, or step S35 in FIG. 4, or step S45 in FIG. 5, or steps S54-56 in FIG. 6. Details are not described again.

S66: In the process in which the flight controller executes the first route task, the task controller determines whether there exists a task that fails in execution.

For example, after step S65, in the process in which the flight controller executes the first route task in the flight zone, the task controller determines in real time whether there exists a task that fails in execution. Optionally, the task that fails in execution includes at least one of the following: a current location of the UAV does not meet a preset location, heading of the UAV does not meet preset heading, and a flight task of the UAV does not meet a preset task.

For example, it is already set that a location where the UAV needs to fly is a location 1, and the task controller of the UAV needs to determine whether the current location of the UAV is the location 1. If determining that the current location of the UAV is not the location 1, the task controller determines that task execution fails.

For another example, it is already set that a flight task of the UAV in a flight zone 1 is aerial photographing, and the task controller of the UAV needs to determine whether the UAV finishes aerial photographing in the flight zone 1, or whether photographing quality meets a task requirement. If determining the UAV does not finish aerial photographing in the flight zone 1 or the photographing quality does not meet the task requirement, the task controller determines that task execution fails.

For still another example, if determining that the UAV does not fly according to a corresponding route shape in the flight zone 1, the task controller of the UAV determines that task execution fails.

S67: If the task controller determines that there exists a task that fails in execution, after the flight controller executes the first route task, the task controller determines a second route task according to location information corresponding to the task that fails in execution.

For example, after step S66, if the task controller determines that there exists a task that fails in execution, the task controller needs to record in real time location information corresponding to the task that fails in execution. Then, after the flight controller executes the first route task, the task controller generates a second route task. For a method of generating the second route task by the task controller, reference can be made to the method of generating the first route task by the task controller in the foregoing embodiment. The second route task includes waypoint information or zone information of the task that fails in execution. The waypoint information includes waypoint location information, and the zone information includes waypoint location information in a zone or location information of the zone. Further, the second route task may also include a flight task, a route shape or the like corresponding to the location information.

S68: If the task controller determines that there exists a task that fails in execution, the task controller sends a task execution failure message to the communications interface.

S69: The communications interface sends the task execution failure message to the ground station.

For example, after step S66, if the task controller determines that there exists a task that fails in execution, the task controller needs to send, in real time, a feedback message to the ground station through the communications interface, where the feedback message indicates that task execution fails.

An execution sequence between step S67 and steps S68-S69 is not limited. Step S67 may be performed first, and then steps S68-S69 are performed; or steps S68-S69 may be performed first, and then step S67 is performed; or step S67 and steps S68-S69 may be performed simultaneously.

Optionally, S610: the communications interface receives a control instruction that is sent by the ground station with respect to the second route task.

For example, after step S69, because the ground station receives the feedback message from the UAV and determines that a task execution failure occurs in the UAV, the ground station may send a control instruction to the communications interface of the UAV, where the control instruction instructs the UAV to execute the second route task.

Optionally, S611: the communications interface sends, to the second route task, a control instruction to the task controller with respect.

Optionally, S612: the task controller sends the second route task to the flight controller according to the control instruction.

For example, after receiving the control instruction, the task controller sends the generated second route task to the flight controller.

Optionally, S613: the flight controller executes the second route task according to the control instruction.

In this embodiment, in the process executing the first route task during flight control, the task controller may determine whether there exists a task that fails in execution. Moreover, the task controller may determine a second route task according to location information corresponding to the task that fails in execution. Therefore, the task controller of the UAV can ensure that a new route task is generated when the UAV fails in task execution, and ensure that the UAV finishes a complete route task.

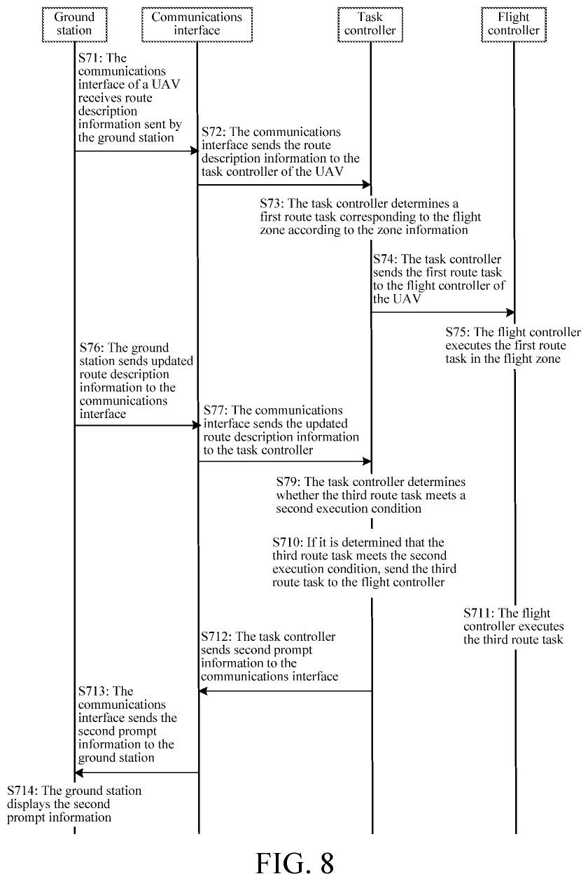

FIG. 8 is a signaling diagram of further another route information transmission method according to an embodiment of the present application. As shown in FIG. 8, the method includes the following steps:

S71: A communications interface of a UAV receives route description information sent by a ground station, where the route description information includes zone information, and the zone information includes location information of a flight zone.

For example, for this step, reference can be made to step S11 in FIG. 2, or step S21 in FIG. 3, or step S31 in FIG. 4, or step S41 in FIG. 5, or step S51 in FIG. 6. Details are not described again.

S72: The communications interface sends the route description information to a task controller of the UAV.

S73: The task controller determines a first route task corresponding to the flight zone according to the zone information.

For example, for this step, reference can be made to step S13 in FIG. 2, or steps S23-S24 in FIG. 3, or steps S33-S34 in FIG. 4, or steps S43-S44 in FIG. 5, or step S53 in FIG. 6. Details are not described again.

S74: The task controller sends the first route task to a flight controller of the UAV.

S75: The flight controller executes the first route task in the flight zone.

For example, for this step, reference can be made to step S15 in FIG. 2, or step S25 in FIG. 3, or step S35 in FIG. 4, or step S45 in FIG. 5, or steps S54-56 in FIG. 6. Details are not described again.

S76: In the process in which the flight controller executes the first route task, the ground station sends updated route description information to the communications interface, where the updated route description information includes updated waypoint information or updated zone information.

For example, in the process in which the flight controller of the UAV flies according to the first route task, the ground station may update the route description information sent to the UAV. For example, the ground station may adjust the route description information, or a user inputs adjusted route description information into the ground station. The ground station generates updated route description information, and sends the updated route description information to the communications interface of the UAV.

Optionally, the updated route description information includes updated waypoint information, or the updated route description information includes updated zone information, or the updated route description information includes updated waypoint information and updated zone information. There may be one or more pieces of updated waypoint information, and there may be one or more pieces of updated zone information. Each piece of updated zone information includes location information of a flight zone.

S77: The communications interface sends the updated route description information to the task controller.

S78: The task controller updates the first route task to be a third route task according to the updated route description information.

For example, the task controller generates a third route task according to the updated route description information, the zone information corresponding to the first route task, and the waypoint information corresponding to the first route task; the task controller replaces the first route task with the third route task.

For a method of generating the third route task by the task controller, reference can be made to steps S23-S24 in FIG. 3, or steps S33-S34 in FIG. 4, or steps S43-S44 in FIG. 5.

Optionally, S79: the task controller determines, according to a current execution state of the first route task, whether the third route task meets a second execution condition.

For example, the task controller may obtain a current execution state when the UAV flies according to the first route task; the task controller determines, according to the current execution state, whether the third route task meets a second execution condition. That is, the task controller determines, according to the current execution state, whether the third route task can be executed.

Optionally, the current execution state when the UAV flies according to the first route task includes at least one of the following: an execution state of the first route task, current location information of the UAV, heading and attitude information of the UAV, a battery capacity of the UAV, a current battery level of the UAV, and current environment information of the UAV. For example, the execution state of the first route task includes whether execution of the first route task is finished, and a location relationship between a current execution location on the first route task and the third route task.

Optionally, the second execution condition includes at least one of the following: a first execution condition, execution of the first route task is finished, an intersection exists between the flight zone represented by the first route task and the flight zone represented by the third route task, preset route information, preset flight environment, preset flight task, and preset state information.

For example, the task controller may obtain that execution of the first route task is not finished, and then the task controller determines that the third route task does not meet the second execution condition.

For another example, the task controller may obtain a current location of the UAV, that is, the current execution location on the first route task, and then determine whether an intersection exists between the current location of the UAV and the flight zone represented by the third route task; if no, the task controller determines that the third route task does not meet the second execution condition; if yes, the task controller determines that the third route task meets the second execution condition. In such a case, the task controller of the UAV may use the current location as a start waypoint for execution of the third route task, or the task controller of the UAV may fly to a waypoint which is in the current location and nearest to the current location, and use the waypoint as a start waypoint for execution of the third route task.

Optionally, S710: if determining that the third route task meets the second execution condition, the task controller sends the third route task to the flight controller.

For example, after step S79, once determining that the third route task meets the second execution condition, the task controller sends the third route task to the flight controller.

S711: The flight controller executes the third route task.

For example, after S710, when the flight controller receives the third route task, it can be determined that the task controller instructs the flight controller to execute the third route task, and therefore, the flight controller flies on the flight route corresponding to the third route task, and executes the flight task corresponding to the third route task.

S712: If determining that the third route task does not meet the second execution condition, the task controller sends second prompt information to the communications interface, so as to indicate that execution of the third route task fails.

S713: The communications interface sends the second prompt information to the ground station.

For example, after step S79, once determining that the third route task does not meet the second execution condition, the task controller sends second prompt information to the ground station through the communications interface, where the second prompt information represents that execution of the third route task fails, and the second prompt information may further include a cause of the failure.

S714: The ground station displays the second prompt information.

In this embodiment, the task controller of the UAV may receive updated route description information sent by the ground station, where the updated route description information includes updated waypoint information or updated zone information; the task controller may generate a new route task according to the updated route description information. The ground station no longer needs to send a complete route task to the UAV, but only needs to send changed waypoint information or changed zone information to the UAV; then, the UAV generates a new flight route automatically and further generates a new route task. As such, the data amount of information transmitted between the ground station and the UAV can be reduced, thereby improving transmission efficiency of the information, and improving route execution efficiency of the UAV.

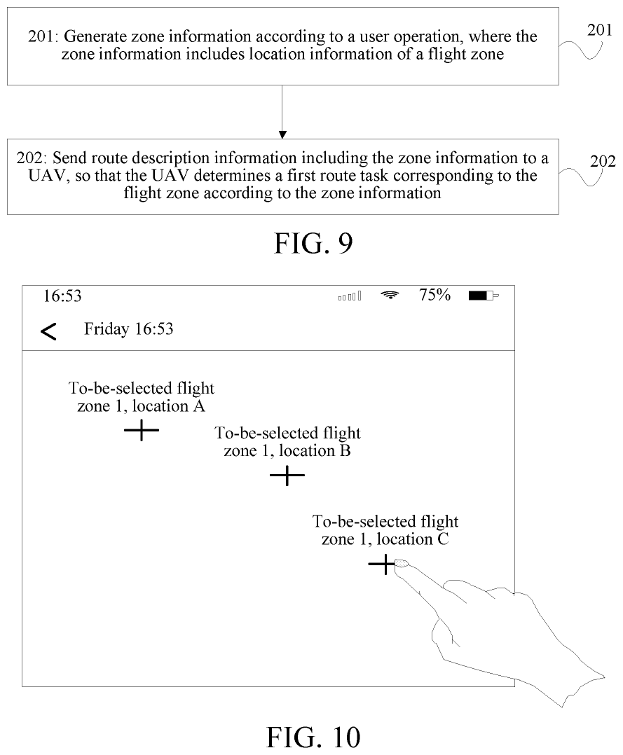

FIG. 9 is a signaling diagram of further another route information transmission method according to an embodiment of the present application. As shown in FIG. 9, the method can be applied to a ground station, and the method includes the following steps:

S201: Generate zone information according to a user operation, where the zone information includes location information of a flight zone.

For example, this embodiment is executed by a ground station. A user may perform man-machine interaction with the ground station. The user may operate the ground station, to accomplish a user operation, so that the user inputs instruction information to the ground station. The instruction information indicates location information of a flight zone; therefore, the ground station can generate zone information according to the instruction information of the user.

For example, FIG. 10 is a first schematic diagram of interface display according to an embodiment of the present application. As shown in FIG. 10, a screen of the ground station may display to-be-selected flight zones proportionally, for example, the screen displays three to-be-selected flight zones, which are a to-be-selected flight zone 1, a to-be-selected flight zone 2, and a to-be-selected flight zone 3 respectively. Moreover, the screen of the ground station may display a location of each flight zone. For example, the location of the to-be-selected flight zone 1 is A, the location of the to-be-selected flight zone 2 is B, and the location of the to-be-selected flight zone 3 is C. The user may click on the screen of the ground station, to select one or more flight zones.

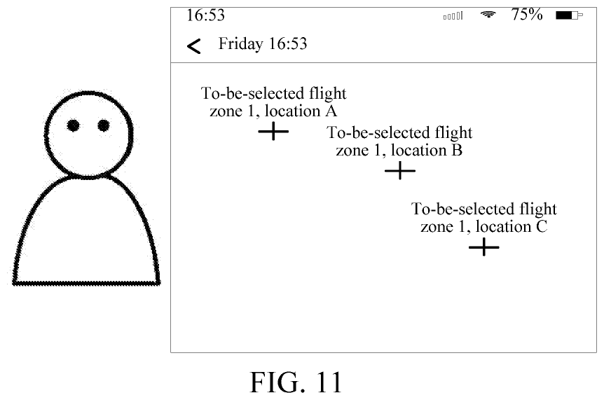

For another example, FIG. 10 is a second schematic diagram of interface display according to an embodiment of the present application. As shown in FIG. 11, a screen of the ground station may display to-be-selected flight zones proportionally, for example, the screen displays three to-be-selected flight zones, which are a to-be-selected flight zone 1, a to-be-selected flight zone 2, and a to-be-selected flight zone 3 respectively. Moreover, the screen of the ground station may display a location of each flight zone. For example, the location of the to-be-selected flight zone 1 is A, the location of the to-be-selected flight zone 2 is B, and the location of the to-be-selected flight zone 3 is C. The user may send a voice to the ground station, or the user sends an instruction to the ground station by using a remote control device connected to the ground station, so as to select one or more flight zones.

S202: Send route description information including the zone information to a UAV, so that the UAV determines a first route task corresponding to the flight zone according to the zone information.

For example, the ground station generates route description information according to the zone information, and sends the route description information to a communications interface of the UAV. Then, the communications interface of the UAV sends the route description information to a task controller of the UAV. The task controller of the UAV generates a first route task according to the route description information. The task controller of the UAV sends the first route task to a flight controller of the UAV. Then, the flight controller of the UAV controls the UAV to fly according to a flight route and a flight task represented by the first route task. For a process of determining the first route task corresponding to the flight zone by the UAV, reference can be made to the embodiments shown in FIG. 1 to FIG. 8.

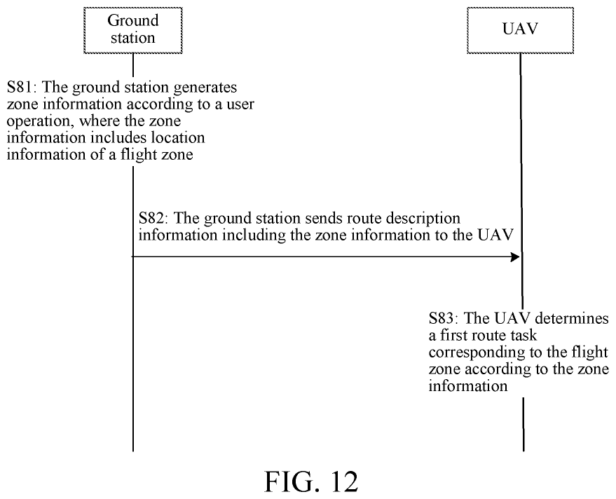

FIG. 12 is a signaling diagram of further another route information transmission method according to an embodiment of the present application. FIG. 12 is used for executing the process of further another route information transmission method provided in FIG. 9. As shown in FIG. 12, the method includes the following steps:

S81: A ground station generates zone information according to a user operation, where the zone information includes location information of a flight zone.

For example, for this step, reference can be made to step S201 in FIG. 9. Details are not described again.

S82: The ground station sends route description information including the zone information to a UAV.

For example, for this step, reference can be made to step S202 in FIG. 9. Details are not described again.

S83: The UAV determines a first route task corresponding to the flight zone according to the zone information.

For example, for this step, reference can be made to step S202 in FIG. 9 and the foregoing method embodiment applied to the UAV. Details are not described again.

In this embodiment, the ground station can interact with a user, thereby generating route description information including zone information. The ground station sends the route description information to the UAV. Zone information required for flight is sent to the UAV, so that the UAV can generate a flight route according to the zone information. Therefore, the ground station no longer needs to send complete route information to the UAV; instead, the UAV generates the flight route automatically and then obtains a route task. As such, the data amount of information transmitted between the ground station and the UAV can be reduced, thereby improving transmission efficiency of the information and improving route execution efficiency of the UAV.

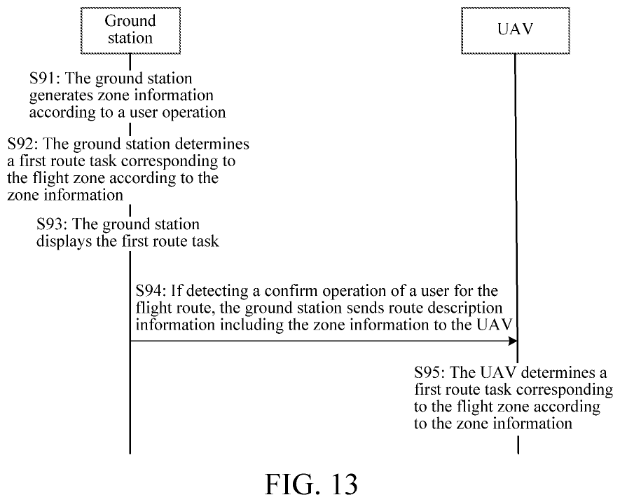

FIG. 13 is a signaling diagram of further another route information transmission method according to an embodiment of the present application. As shown in FIG. 13, the method includes the following steps:

S91: A ground station generates zone information according to a user operation, where the zone information includes location information of a flight zone.

For example, for this step, reference can be made to step S81 in FIG. 12. Details are not described again.

S92: The ground station determines a first route task corresponding to the flight zone according to the zone information.

For example, after generating the zone information, the ground station may generate a first route task according to the zone information. For a method of generating the first route task by the ground station, reference can be made to the method of generating the first route task by the task controller of the UAV in FIG. 1 to FIG. 8. Specifically, the ground station may also be configured with a task controller, where the task controller of the ground station implements functions the same as the task controller of the UAV. That is, the task controller of the ground station can also generate the first route task according to the zone information. Moreover, the task controller of the ground station generates a route task by using the same method as the task controller of the UAV. For example, the task controller of the ground station and the task controller of the UAV run the same algorithm or code to implement the function of generating a route task.

S93: The ground station displays the first route task.

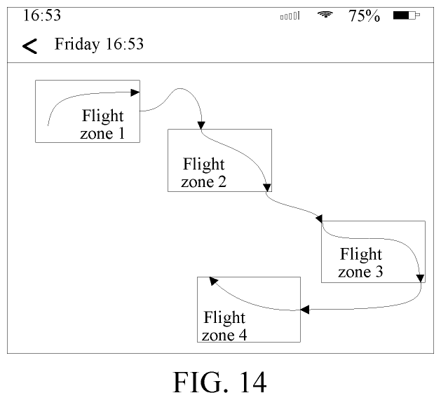

For example, after generating the first route task, the ground station can display the generated first route task on a screen of the ground station. FIG. 14 is a third schematic diagram of interface display of a ground station according to an embodiment of the present application. As shown in FIG. 14, the ground station may display the first route task in a graphical manner. For example, a flight route in each flight zone, including a route shape, one or more waypoints, and the like, and a flight route formed by the flight zones are displayed; location information of each flight zone, a flight task corresponding to each flight zone or waypoint, and the like are displayed.

An execution sequence between steps S92-S93 and step S94 is not limited.

S94: If detecting a confirm operation of a user for the flight route, the ground station sends route description information including the zone information to a UAV.

For example, after step S91, the ground station may display the generated route description information, so that the user can view the route description information. The ground station may display operation options, so that the user chooses whether to confirm the route description information generated by the ground station. The user may input a confirm operation by using a touch operation or a voice operation, to choose to confirm the route description information generated by the ground station. Further, the ground station receives the confirm operation input by the user. The confirm operation represents that the user accepts the route description information generated by the ground station, that is, the user accepts the route task generated by the ground station.

For example, FIG. 15 is a fourth schematic diagram of interface display of a ground station according to an embodiment of the present application. As shown in FIG. 15, the screen of the ground station displays the generated route description information. The ground station displays two operation options, which are “confirm” and “cancel” respectively. The user can touch the screen of the ground station. The user selects “confirm”, and then the ground station receives the confirm operation input by the user.

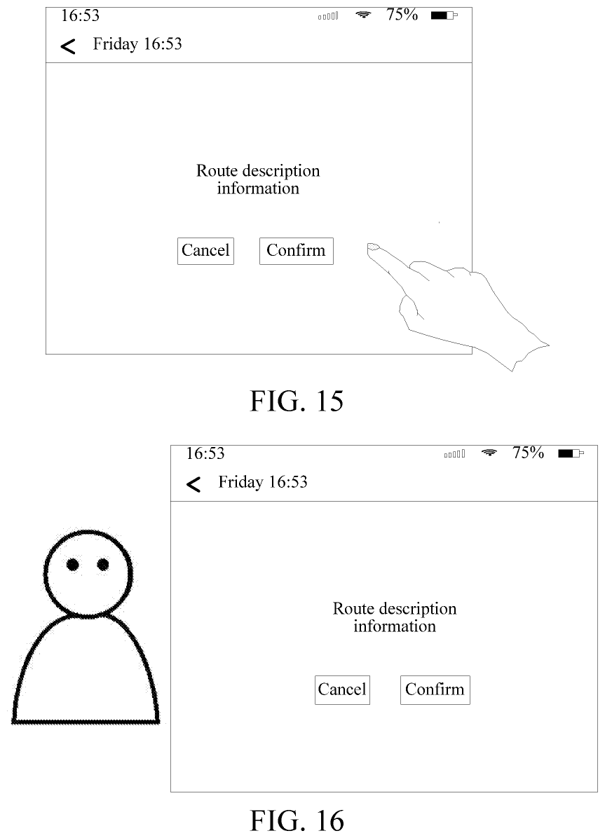

For example, FIG. 16 is a fifth schematic diagram of interface display of a ground station according to an embodiment of the present application. As shown in FIG. 16, the screen of the ground station displays the generated route description information. The ground station displays two operation options, which are “confirm” and “cancel” respectively. The user can send a voice “confine” to the ground station, and then the ground station receives the confirm operation input by the user.

In an implementation, the ground station displays the generated first route task. The user may input a modification operation with respect to the first route task, for example, modifying a flight shape of a flight zone, or modifying an execution location of a flight task. After receiving the modification operation of the user for the first route task, the ground station modifies the first route task correspondingly, determines route description information based on the modified first route task, and displays the determined route description information. After receiving a confirm operation of the user, the ground station sends the route description information to the UAV, so that the task controller of the UAV determines a first route task according to the route description information. Alternatively, after receiving the modification operation of the user for the first route task, the ground station saves the modification information, and adds the modification information and zone information to the route description information, so that after the UAV receives the route description information, the task controller of the UAV can generate a first route task according to the zone information, and can modify the first route task according to the modification information, thereby obtaining a route task required by the user.

In this manner, precise route description information can be obtained, so that the UAV can precisely execute, according to the received route description information, the route task required by the user.

S95: The UAV determines a first route task corresponding to the flight zone according to the zone information.

For example, for this step, reference can be made to step S83 in FIG. 12. Details are not described again.

In this embodiment, the ground station can generate and display a first route task, so that the user can see the first route task. Therefore, the user can confirm whether to select the first route task as a route task of the UAV. Therefore, the user can participate in confirmation of the route task, improving user experience.

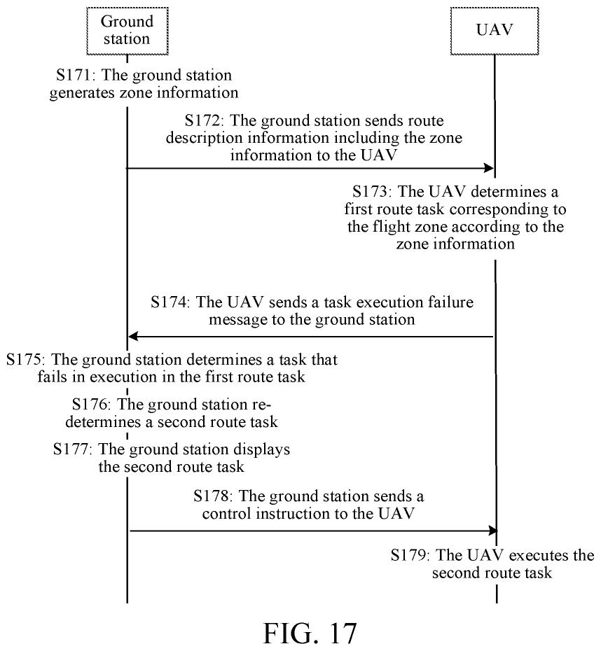

FIG. 17 is a signaling diagram of further another route information transmission method according to an embodiment of the present application. As shown in FIG. 17, the method includes the following steps:

S171: A ground station generates zone information according to a user operation, where the zone information includes location information of a flight zone.

For example, for this step, reference can be made to step S81 in FIG. 12. Details are not described again.

S172: The ground station sends route description information including the zone information to a UAV.

For example, for this step, reference can be made to step S82 in FIG. 12. Details are not described again.

S173: The UAV determines a first route task corresponding to the flight zone according to the zone information.

For example, for this step, reference can be made to step S83 in FIG. 12. Details are not described again. Moreover, for steps S171-S173, reference can be made to the steps in FIG. 13.

S174: The UAV sends, to the ground station, a task execution failure message that is fed back with respect to the first route task.

S175: The ground station determines a task that fails in execution in the first route task.

For example, when executing the first route task, if the UAV fails in executing the first route task, the UAV sends a feedback message to the ground station. The feedback message represents that there exists a task that fails in execution when the UAV executes the first route task.

Then, the ground station determines a task that fails in execution in the first route task. Optionally, the feedback message indicates a task that fails in execution in the first route task. Therefore, the ground station can parse the feedback message; the ground station obtains the task that fails in execution in the first route task. Alternatively, after receiving the feedback message, the ground station sends an obtaining instruction to the UAV. The UAV sends, to the ground station, the task that fails in execution in the first route task.

S176: The ground station re-determines a second route task according to the task that fails in execution.

For example, after obtaining, in step S175, the task that fails in execution in the first route task, the ground station may re-generate a second route task according to the task that fails in execution in the first route task.

Optionally, the task that fails in execution in the first route task indicates location information corresponding to the task that fails in execution. The ground station re-generates a second route task according to the location information corresponding to the task that fails in execution. For example, the ground station may re-generate a second route task by using the location information corresponding to the task that fails in execution as a start point.

S177: The ground station displays the second route task.

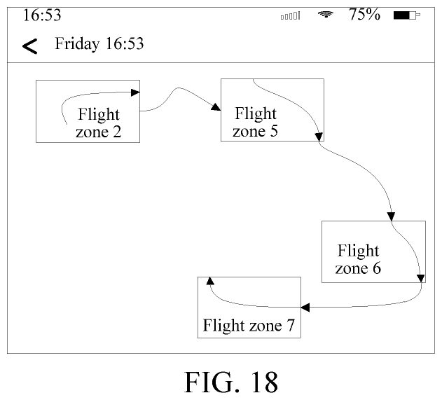

For example, FIG. 18 is a sixth schematic diagram of interface display of a ground station according to an embodiment of the present application. As shown in FIG. 18, a screen of the ground station displays the second route task, so that the user can view the second route task. For example, the task that fails in execution in the first route task indicates that the location information corresponding to the task that fails in execution is a location of a flight zone 2. Then, the ground station can generate a second route task by using the flight zone 2 as a start location. The second route task includes the flight zone 2, a flight zone 5, a light zone 6 and a flight zone 7. The ground station may display a flight route in each flight zone, and a flight route among the flight zones.

S178: If detecting a confirm operation of the user for the second route task, the ground station sends a control instruction to the UAV.

For example, when displaying the second route task, the ground station may display operation options, so that the user chooses whether to confirm the second route task generated by the ground station. The user may input a confirm operation by using a touch operation, a voice operation, or the like, to choose to confirm the second route task generated by the ground station. Further, the ground station receives the confirm operation input by the user. The confirm operation represents that the user accepts the second route task generated by the ground station.

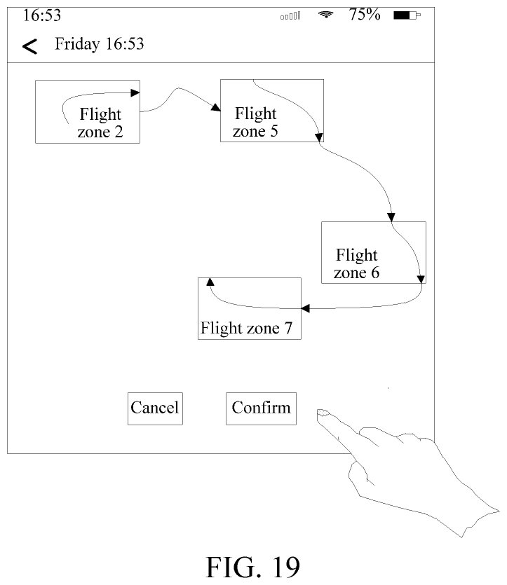

For example, FIG. 19 is a seventh schematic diagram of interface display of a ground station according to an embodiment of the present application. As shown in FIG. 19, the screen of the ground station displays the generated second route task. The ground station displays two operation options, which are “confirm” and “cancel” respectively. The user can touch the screen of the ground station. The user selects “confirm”, and then the ground station receives the confirm operation input by the user.

Then, the ground station sends a control instruction to the communications interface of the UAV. The control instruction instructs the UAV to execute the second route task, and the control instruction indicates the second route task.

S179: The UAV executes the second route task after receiving the control instruction.

For example, after receiving the control instruction sent by the ground station, the UAV can obtain the second route task indicated by the control instruction. Then, the UAV executes a flight route and a flight task that are represented by the second route task.

In another implementation, the UAV re-determines a second route task according to the task that fails in execution, and feeds back, to the ground station, zone information or waypoint information corresponding to the task that fails in execution. The ground station can calculate the same second route task according to the information fed back by the UAV, and can display the second route task, so that the user confirms the second route task. After receiving a confirm operation of the user for the second route task, the ground station sends a control instruction to the UAV. The control instruction is used to indicate that UAV can execute the second route task. Further, the UAV can execute the second route task.

In this manner, the amount of data transmitted between the UAV and the ground station can be further reduced.

Definitely, after displaying the second route task, the ground station can also receive a modification operation of the user for the second route task. For this implementation, reference can be made to the foregoing modification operation of the user for the first route task. The implementation is not limited herein.

In this embodiment, when the UAV fails in executing the first route task, the ground station can re-determine a second route task according to a task that fails in execution, thereby ensuring that the UAV can fly normally and ensuring that the UAV can accomplish the flight task. Moreover, the ground station can display the second route task, and determine, according to an instruction of the user, whether to instruct the UAV to execute the second route task, thereby enhancing interaction between the user and the UAV during flight.

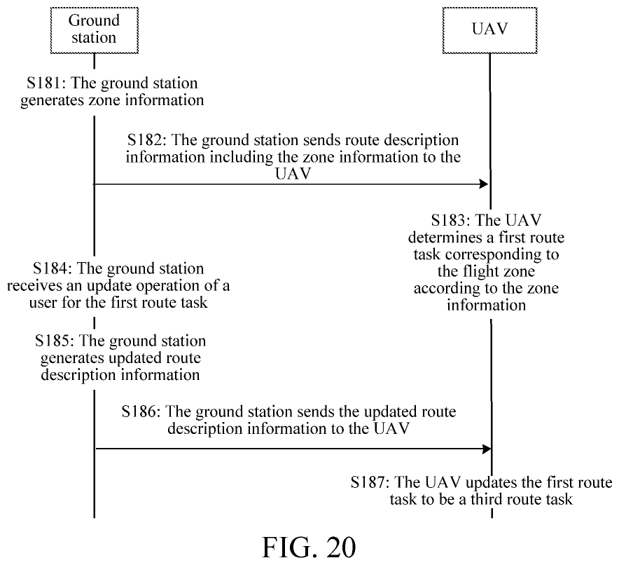

FIG. 20 is a signaling diagram of further another route information transmission method according to an embodiment of the present application. As shown in FIG. 20, the method includes the following steps:

S181: A ground station generates zone information according to a user operation, where the zone information includes location information of a flight zone.

For example, for this step, reference can be made to step S81 in FIG. 12. Details are not described again.

S182: The ground station sends route description information including the zone information to a UAV.

For example, for this step, reference can be made to step S82 in FIG. 12. Details are not described again.

S183: The UAV determines a first route task corresponding to the flight zone according to the zone information.

For example, for this step, reference can be made to step S83 in FIG. 12. Details are not described again. Moreover, for steps S181-S183, reference can be made to the steps in FIG. 13.

S184: The ground station receives an update operation of a user for the first route task.

For example, in the process in which the UAV executes the first route task, the user may change the first route task; the user may input a change operation to the ground station.

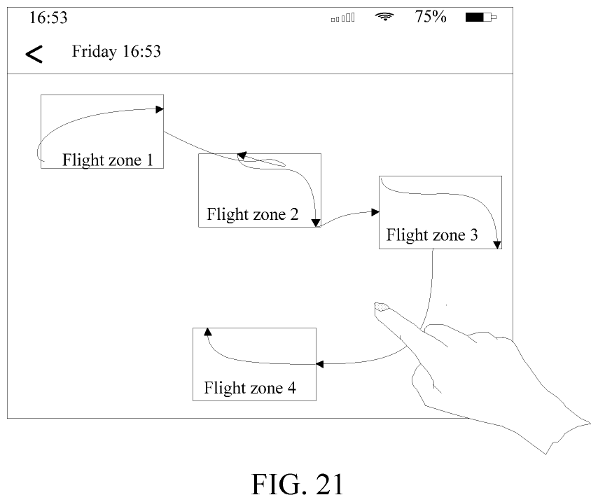

For example, FIG. 21 is an eighth schematic diagram of interface display of a ground station according to an embodiment of the present application. As shown in FIG. 21, the ground station can display the first route task, that is, flight zones in the first route task, flight routes of the first route task, and flight tasks of the first route task are displayed. The user can touch the screen of the ground station, to change any one or more of the flight zones, the flight route, and the flight task. For example, the user touches the screen of the ground station to change the flight route.

S185: The ground station generates updated route description information according to the update operation, where the updated route description information includes updated waypoint information or updated zone information.

For example, when the user changes the flight zone and/or flight route, the ground station changes the zone information in the previous route description information; the user may further change the waypoint information in the previous route description information, and then the ground station changes the waypoint information in the previous route description information.

S186: The ground station sends the updated route description information to the UAV.

For example, after step S185, the ground station can generate updated route description information according to the change made by the user. Then, the ground station sends the updated route description information to a communications interface of the UAV.

S187: The UAV updates the first route task to be a third route task according to the updated route description information.

For example, the communications interface of the UAV sends the updated route description information to a task controller of the UAV. The task controller of the UAV may generate a third route task according to the updated route description information. Then, the task controller of the UAV replaces the previous first route task with the third route task. The task controller of the UAV sends the third route task to a flight controller of the UAV, and the flight controller of the UAV executes the third route task.

Optionally, the task controller of the UAV may further determine, according to flight state information of the UAV, whether the third route task can be executed, and feed back a determination result to the ground station through the communications interface of the UAV.

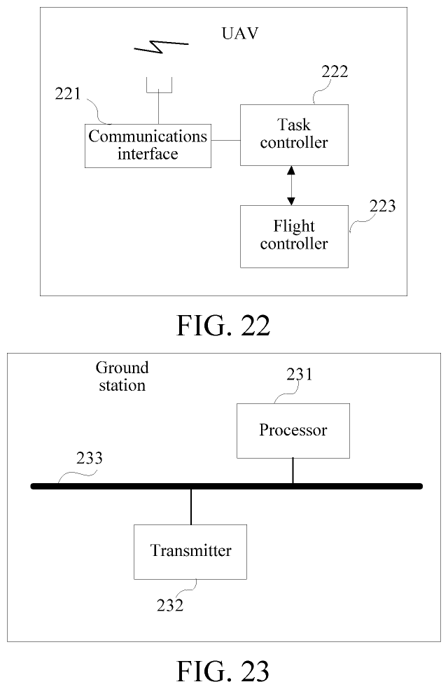

FIG. 22 is a schematic structural diagram of a UAV according to an embodiment of the present application. As shown in FIG. 22, the UAV includes: a communications interface 221, a task controller 222, and a flight controller 223.

The communications interface 221 and the flight controller 223 are connected to the task controller 222 separately.

The communications interface 221 is configured to receive route description information sent by a ground station, and send the route description information to the task controller 222, where the route description information includes zone information, and the zone information includes location information of a flight zone.

The task controller 222 is configured to determine a first route task corresponding to the flight zone according to the zone information, and send the first route task to the flight controller 223.

The flight controller 223 is configured to execute the first route task in the flight zone.

For example, the communications interface 221 can perform step S101 in the method shown in FIG. 1, the ask controller 222 can perform step S102 in the method shown in FIG. 1, and the flight controller 223 can perform step S101 in the method shown in FIG. 1. Optionally, the communications interface 221 may be a structure integrating a transmitter and a receiver.

For this embodiment, reference may be made to the technical solutions of the embodiments shown in FIG. 1 to FIG. 2. The implementation principle and technical effect of this embodiment are similar to those of the embodiments shown in FIG. 1 to FIG. 2. Details are not described herein again.

Based on the embodiment shown in FIG. 22, the task controller 222 is specifically configured to: determine location information of a start waypoint and a route shape according to the zone information; and determine a flight route in the first route task according to the location information of the start waypoint and the route shape. In this case, the task controller 222 may perform steps S23-S24 in the method shown in FIG. 3.

Alternatively, the task controller 222 is specifically configured to: determine waypoint information in the flight zone according to the zone information; and determine a flight route in the first route task according to the waypoint information. Optionally, the task controller 222 is specifically configured to: determine, according to the zone information, location information of a start waypoint and location information of a terminal waypoint in the flight zone. In this case, the task controller 222 may perform steps S33-S34 in the method shown in FIG. 4.

Based on the embodiment shown in FIG. 22, the task controller 222 is specifically configured to: determine, according to the zone information, whether there exists a no-fly zone; and if there exists a no-fly zone, determine a flight route that corresponds to the flight zone and avoids the no-fly zone. In this case, the task controller 222 may perform steps S43-S44 in the method shown in FIG. 5.

Based on the embodiment shown in FIG. 22, the task controller 222 is further configured to: obtain flight state information after determining the first route task corresponding to the flight zone according to the zone information; and determine, according to the flight state information, whether the first route task meets a first execution condition. In this case, the task controller 222 may perform step S54 in the method shown in FIG. 6.

The flight controller 223 is specifically configured to: execute the first route task in the flight zone if the first route task meets the first execution condition. In this case, the flight controller 223 may perform step S56 in the method shown in FIG. 6.

The task controller 222 is further configured to: send first prompt information to the ground station by using the communications interface 221 if the first route task does not meet the first execution condition, so as to indicate that execution of the first route task fails. In this case, the task controller 222 may perform step S57 in the method shown in FIG. 6.

Based on the embodiment shown in FIG. 22, the task controller 222 is further configured to: in the process of executing the first route task, determine whether there exists a task that fails in execution; and if there exists a task that fails in execution, after executing the first route task, determine a second route task according to location information corresponding to the task that fails in execution. In this case, the task controller 222 may perform steps S66-S67 in the method shown in FIG. 7.

The task controller 222 is further configured to: send a task execution failure message to the ground station by using the communications interface 221 if there exists a task that fails in execution. In this case, the task controller 222 may perform step S68 in the method shown in FIG. 7.

The task controller 222 is further configured to: receive, by using the communications interface 221, a control instruction that is sent by the ground station with respect to the second route task, and send the control instruction to the flight controller 223. In this case, the task controller 222 may perform step S612 in the method shown in FIG. 7.

The flight controller 223 is further configured to execute the second route task according to the control instruction. In this case, the flight controller 223 may perform step S613 in the method shown in FIG. 7.

Based on the embodiment shown in FIG. 22, the communications interface 221 is further configured to: receive updated route description information sent by the ground station, and send the updated route description information to the task controller 222, where the updated route description information includes updated waypoint information or updated zone information. In this case, the communications interface 221 may perform steps S76-S77 in the method shown in FIG. 8.

The task controller 222 is further configured to update the first route task to be a third route task according to the updated route description information. In this case, the task controller 222 may perform step S78 in the method shown in FIG. 8.

The task controller 222 is further configured to: determine, according to a current execution state of the first route task, whether the third route task meets a second execution condition; execute the third route task by using the flight controller 223 if the third route task meets the second execution condition; and send second prompt information to the ground station by using the communications interface 221 if the third route task does not meet the second execution condition, so as to indicate that execution of the third route task fails. In this case, the task controller 222 may perform steps S79-S710 and S712 in the method shown in FIG. 8, and the flight controller 223 may perform steps S711-S712 in the method shown in FIG. 8

The UAV in the embodiment shown in FIG. 22 may be configured to execute the technical solutions of the embodiments shown in FIG. 1 to FIG. 8 in the foregoing method. The implementation principle and technical effect of the UAV in this embodiment are similar to those of the embodiments shown in FIG. 1 to FIG. 8. Details are not described herein again.

The communications interface in the UAV may be a wireless communications interface, and may implement a communication connection with the ground station by using a private communications protocol or a general communications protocol, for example, a Wireless Fidelity (Wi-Fi) protocol. The communications interface may include an antenna, a transceiver, or other apparatuses, which are not limited herein.

The task controller in the UAV may be configured to implement route task-related functions, for example, generating, modification, and update of a route task. The task controller of the UAV may be implemented in one or more of the following manners: one or more specific integrated circuits, one or more processors, one or more field programmable gate array (FPGAs), and the like.

The flight controller of the UAV may include elements for controlling a power system and processing flight data, for example, a processor and an electronic speed regulator.

The processor may include a central processing unit (CPU), a microprocessor, a digital signal processor, or a special-purpose processor, such as a task processor or a flight processor.

Definitely, the UAV may further include other systems or apparatuses, for example, a flight auxiliary system including a visual system, a radar system, a Time of Flight (TOF) unit, an ultrasonic unit, an inertial sensor unit, and the like; a power system including a motor, a propeller, and the like; a task execution apparatus, such as a camera or a spreading apparatus; and a data transmission system configured to implement data transmission with the ground station. The data transmission system may include the foregoing communications interface.

The apparatuses or systems in the UAV may be connected by using a bus or in another manner, which is not limited herein.

FIG. 23 is a schematic structural diagram of a ground station according to an embodiment of the present application. As shown in FIG. 23, the ground station includes: a processor 231 and a transmitter 232, the processor 231 and the transmitter 232 being connected.

The processor 231 is configured to generate zone information according to a user operation, where the zone information includes location information of a flight zone

The transmitter 232 is configured to send route description information including the zone information to a UAV, so that the UAV determines a first route task corresponding to the flight zone according to the zone information.

For example, the processor 231 can perform step S201 in the method shown in FIG. 9, and the transmitter 232 can perform step S202 in the method shown in FIG. 9.

Optionally, the ground station may further include a bus 233. The processor 231 and the transmitter 232 may be interconnected by using the bus 233. The bus 233 may be a peripheral component interconnect (PCI) bus, an extended industry standard architecture (EISA) bus, or the like. The bus 233 may be classified into an address bus, a data bus, a control bus, and the like. For ease of illustration, only one bold line is used to represent the bus 233 in FIG. 23, but this does not mean that there is only one bus or only one type of bus.

In the embodiments of the present application, reference may be made to each other among the foregoing embodiments, and identical or similar steps and nouns are not described in detail again.

Alternatively, some or all of the foregoing modules may also be implemented in the form of an integrated circuit embedded in a chip of the ground station. In addition, the modules may be implemented separately or integrated together. That is, the foregoing modules may be configured as one or more integrated circuits implementing the foregoing method, for example, one or more application specific integrated circuits (ASICs) or one or more processing units. The one or more processing units may be one or more general processing units such as one or more CPUs, or may be one or more special processing units such as one or more digital signal processors, or may be one or more FPGAs, or the like.

For this embodiment, reference may be made to the technical solutions of the embodiments shown in FIG. 9 to FIG. 12. The implementation principle and technical effect of this embodiment are similar to those of the embodiments shown in FIG. 9 to FIG. 12. Details are not described herein again.

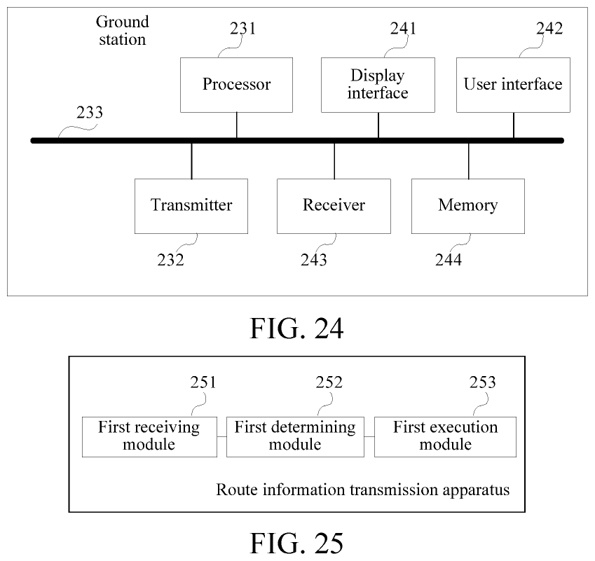

FIG. 24 is a schematic structural diagram of another ground station according to an embodiment of the present application. Based on the embodiment shown in FIG. 23, as shown in FIG. 24, the ground station further includes a display interface 241, and the display interface 241 is connoted to the processor 231. The display interface 241 may be implemented by using an output apparatus. For example, the display interface 241 may be a device such as a display screen.

The processor 231 is further configured to determine the first route task corresponding to the flight zone according to the zone information, and send the first route task to the display interface 241. In this case, the processor 231 may perform step S92 in the method shown in FIG. 13.

The display interface 241 is configured to display the first route task. In this case, the display interface 241 may perform step S93 in the method shown in FIG. 13.

The processor 231 is specifically configured to: send the route description information including the zone information to the UAV by using the transmitter 232 if a confirm operation of a user for the flight route is detected. In this case, the processor 231 may perform step S94 in the method shown in FIG. 13.

The processor 231 is further configured to: if a task execution failure message fed back by the UAV with respect to the first route task is received, determine a task that fails in execution in the first route task; and re-determine a second route task according to the task that fails in execution, and send the second route task to the display interface 241. In this case, the processor 231 may perform steps S174-S176 in the method shown in FIG. 17.

The display interface 241 is further configured to display the second route task. In this case, the display interface 241 may perform step S177 in the method shown in FIG. 17.

The processor 231 is further configured to: if a confirm operation of the user for the second route task is detected, send a control instruction to the UAV by using the transmitter 232, so that the UAV executes the second route task after receiving the control instruction. In this case, the processor 231 may perform step S717 in the method shown in FIG. 17.

The ground station further includes a user interface 242, and the user interface 242 is connected to the processor 231. The user interface may be implemented by using an input apparatus. For example, the user interface may include apparatuses such as a touch panel and a microphone.

The user interface 242 is configured to receive an update operation of the user for the first route task, and send the update operation to the processor 231. In this case, the user interface 242 may perform step S184 in the method shown in FIG. 20. The processor 231 is further configured to generate updated route description information according to the update operation, where the updated route description information includes updated waypoint information or updated zone information. In this case, the processor 231 may perform step S185 in the method shown in FIG. 20. The transmitter 232 is further configured to send the updated route description information to the UAV, so that the UAV updates the first route task to be a third route task according to the updated route description information. In this case, the transmitter 232 may perform step S186 in the method shown in FIG. 20.

Optionally, the ground station provided by this embodiment may further include a receiver 243. The receiver 243 is configured to receive information, instructions, and the like sent by the UAV to the ground station.

Optionally, the ground station provided by this embodiment may further include a memory 244. The memory is configured to store a computer program.

The processor 231 and the display interface 241 may be interconnected by using the bus 233. The processor 231 and the user interface 242 may be interconnected by using the bus 233. The processor 231 and the receiver 243 may be interconnected by using the bus 233.

The processor 231 and the memory 244 may be interconnected by using the bus 233.

The processor 231, such as a CPU, may also be configured as one or more integrated circuits for implementing the foregoing method, for example, one or more ASICs, or one or more microprocessors, or one or more FPGAs. The memory 244 may be a storage device, or may be a collective name of multiple storage elements.

For this embodiment, reference may be made to the technical solutions of the embodiments shown in FIG. 9 to FIG. 21. The implementation principle and technical effect of this embodiment are similar to those of the embodiments shown in FIG. 9 to FIG. 21.

Details are not described herein again.

FIG. 25 is a schematic structural diagram of a route information transmission apparatus according to an embodiment of the present application. The route information transmission apparatus is applied to a UAV, and includes:

a first receiving module 251, configured to receive route description information sent by a ground station, where the route description information includes zone information, and the zone information includes location information of a flight zone;

a first determining module 252, configured to determine a first route task corresponding to the flight zone according to the zone information; and

a first execution module 253, configured to execute the first route task in the flight zone.

For example, the first receiving module 251 may perform step S101 in the method shown in FIG. 1, or may perform step S11 in the method shown in FIG. 2. The first determining module 252 may perform step S102 in the method shown in FIG. 1, or may perform step S13 in the method shown in FIG. 2. The first execution module 253 may perform step S103 in the method shown in FIG. 1, or may perform step S15 in the method shown in FIG. 2.

For this embodiment, reference may be made to the technical solutions of the embodiments shown in FIG. 1 to FIG. 2. The implementation principle and technical effect of this embodiment are similar to those of the embodiments shown in FIG. 1 to FIG. 2. Details are not described herein again.

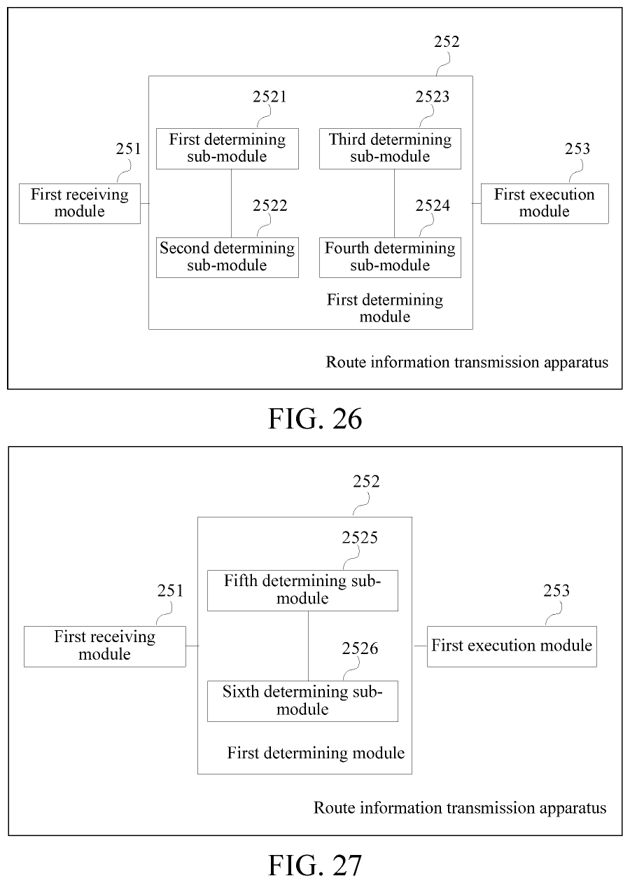

FIG. 26 is a schematic structural diagram of another route information transmission apparatus according to an embodiment of the present application. Based on the embodiment shown in FIG. 25, as shown in FIG. 26, the first determining module 252 includes:

a first determining sub-module 2521, configured to determine location infon iation of a start waypoint and a route shape according to the zone information, where in this case, the first determining sub-module 2521 may perform step S23 in the method shown in FIG. 3;

a second determining sub-module 2522, configured to determine a flight route in the first route task according to the location information of the start waypoint and the route shape, where in this case, the second determining sub-module 2522 may perform step S24 in the method shown in FIG. 3.

Alternatively, the first determining module 252 includes:

a third determining sub-module 2523, configured to determine waypoint information in the flight zone according to the zone information, where in this case, the third determining sub-module 2523 may perform step S33 in the method shown in FIG. 4; and a fourth determining sub-module 2524, configured to determine a flight route in the first route task according to the waypoint information, where in this case, the first determining sub-module 2521 may perform step S34 in the method shown in FIG. 4.

Optionally, the third determining sub-module 2523 is specifically configured to:

determine, according to the zone information, location information of a start waypoint and location information of a terminal waypoint in the flight zone.

For this embodiment, reference may be made to the technical solutions of the embodiments shown in FIG. 3 to FIG. 4. The implementation principle and technical effect of this embodiment are similar to those of the embodiments shown in FIG. 3 to FIG. 4. Details are not described herein again.

FIG. 27 is a schematic structural diagram of still another route information transmission apparatus according to an embodiment of the present application. Based on the embodiment shown in FIG. 25, as shown in FIG. 27, the first determining module 252 includes:

a fifth determining sub-module 2525, configured to determine, according to the zone information, whether there exists a no-fly zone, where in this case, the fifth determining sub-module 2525 may perform step S43 in the method shown in FIG. 5; and a sixth determining sub-module 2526, configured to: if there exists a no-fly zone, determine a flight route that corresponds to the flight zone and avoids the no-fly zone, where in this case, the sixth determining sub-module 2526 may perform step S44 in the method shown in FIG. 5.

For this embodiment, reference may be made to the technical solution of the embodiment shown in FIG. 5. The implementation principle and technical effect of this embodiment are similar to those of the embodiment shown in FIG. 5. Details are not described herein again.

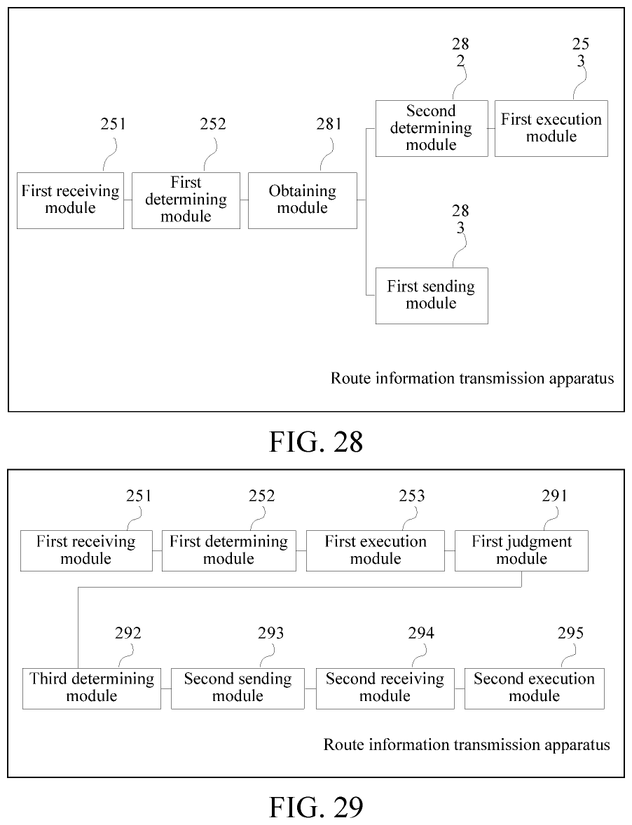

FIG. 28 is a schematic structural diagram of yet another route information transmission apparatus according to an embodiment of the present application. Based on the embodiment shown in FIG. 25, as shown in FIG. 28, the apparatus further includes:

an obtaining module 281, configured to obtain flight state information after the first determining module 252 determines the first route task corresponding to the flight zone according to the zone information, where in this case, the obtaining module 281 may perform step S54 in the method shown in FIG. 6; and a second determining module 282, configured to determine, according to the flight state information, whether the first route task meets a first execution condition, where in this case, the second determining module 282 may perform step S54 in the method shown in FIG. 6.

The first execution module 253 is specifically configured to: execute the first route task in the flight zone if the first route task meets the first execution condition. In this case, the first execution module 253 may perform steps S55-S56 in the method shown in FIG. 6.

The apparatus further includes further includes a first sending module 283, configured to send first prompt information to the ground station if the first route task does not meet the first execution condition, so as to indicate that execution of the first route task fails. In this case, the first sending module 283 may perform steps S57-S58 in the method shown in FIG. 6.

For this embodiment, reference may be made to the technical solution of the embodiment shown in FIG. 6. The implementation principle and technical effect of this embodiment are similar to those of the embodiment shown in FIG. 6. Details are not described herein again.

FIG. 29 is a schematic structural diagram of further another route information transmission apparatus according to an embodiment of the present application. Based on the embodiment shown in FIG. 25, as shown in FIG. 29, the apparatus provided in this embodiment further includes:

a first judgment module 291, configured to: in the process of executing the first route task, determine whether there exists a task that fails in execution, where in this case, the first judgment module 291 may perform step S66 in the method shown in FIG. 7;

a third determining module 292, configured to: if there exists a task that fails in execution, after the first route task is executed, determine a second route task according to location information corresponding to the task that fails in execution, where in this case, the third determining module 292 may perform step S67 in the method shown in FIG. 7;

a second sending module 293, configured to send a task execution failure message to the ground station if there exists a task that fails in execution, where in this case, the second sending module 293 may perform steps S68-S69 in the method shown in FIG. 7;

a second receiving module 294, configured to receive a control instruction that is sent by the ground station with respect to the second route task, where in this case, the second receiving module 294 may perform step S610 in the method shown in FIG. 7; and a second execution module 295, configured to execute the second route task according to the control instruction, where in this case, the second execution module 295 may perform step S613 in the method shown in FIG. 7.

For this embodiment, reference may be made to the technical solution of the embodiment shown in FIG. 7. The implementation principle and technical effect of this embodiment are similar to those of the embodiment shown in FIG. 7. Details are not described herein again.

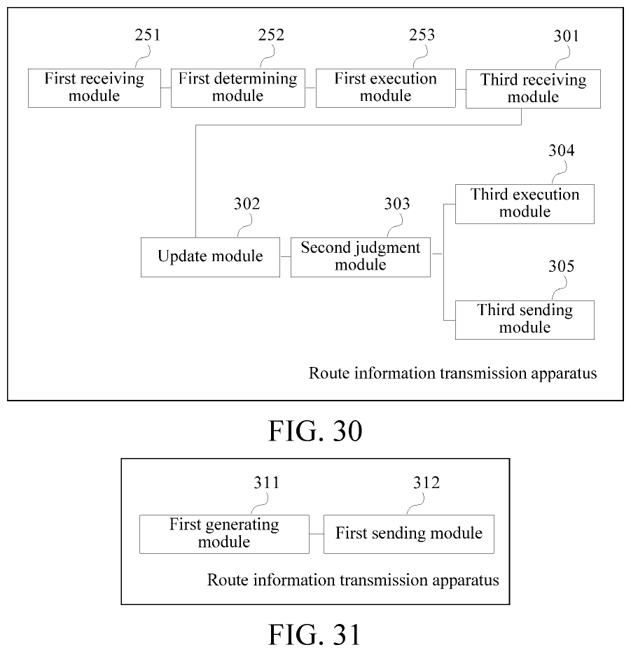

FIG. 30 is a schematic structural diagram of further another route information transmission apparatus according to an embodiment of the present application. Based on the embodiment shown in FIG. 25, as shown in FIG. 30, the apparatus provided in this embodiment further includes:

a third receiving module 301, configured to receive updated route description information sent by the ground station, where the updated route description information includes updated waypoint information or updated zone information, and in this case, the third receiving module 301 may perform step S76 in the method shown in FIG. 8;

an update module 302, configured to update the first route task to be a third route task according to the updated route description information, where in this case, the update module 302 may perform step S78 in the method shown in FIG. 8;

a second judgment module 303, configured to determine, according to a current execution state of the first route task, whether the third route task meets a second execution condition, where in this case, the second judgment module 303 may perform step S79 in the method shown in FIG. 8;

a third execution module 304, configured to execute the third route task if the third route task meets the second execution condition, where in this case, the third execution module 304 may perform step S711 in the method shown in FIG. 8; and a third sending module 305, configured to send second prompt information to the ground station if the third route task does not meet the second execution condition, so as to indicate that execution of the third route task fails, where in this case, the third sending module 305 may perform steps S712-S713 in the method shown in FIG. 8.

For this embodiment, reference may be made to the technical solution of the embodiment shown in FIG. 8. The implementation principle and technical effect of this embodiment are similar to those of the embodiment shown in FIG. 8. Details are not described herein again.

FIG. 31 is a schematic structural diagram of further another route information transmission apparatus according to an embodiment of the present application. As shown in FIG. 31, the apparatus provided in this embodiment includes:

a first generation module 311, configured to generate zone information according to a user operation, where the zone information includes location information of a flight zone, and in this case, the first generation module 311 may perform step S201 in the method shown in FIG. 9 or perform step S81 in the method shown in FIG. 12; and

a first sending module 312, configured to send route description information including the zone information to a UAV, so that the UAV determines a first route task corresponding to the flight zone according to the zone information, where in this case, the first sending module 312 may perform step S202 in the method shown in FIG. 9 or perform step S82 in the method shown in FIG. 12.

For this embodiment, reference may be made to the technical solutions of the embodiments shown in FIG. 9 to FIG. 12. The implementation principle and technical effect of this embodiment are similar to those of the embodiments shown in FIG. 9 to FIG. 12. Details are not described herein again.

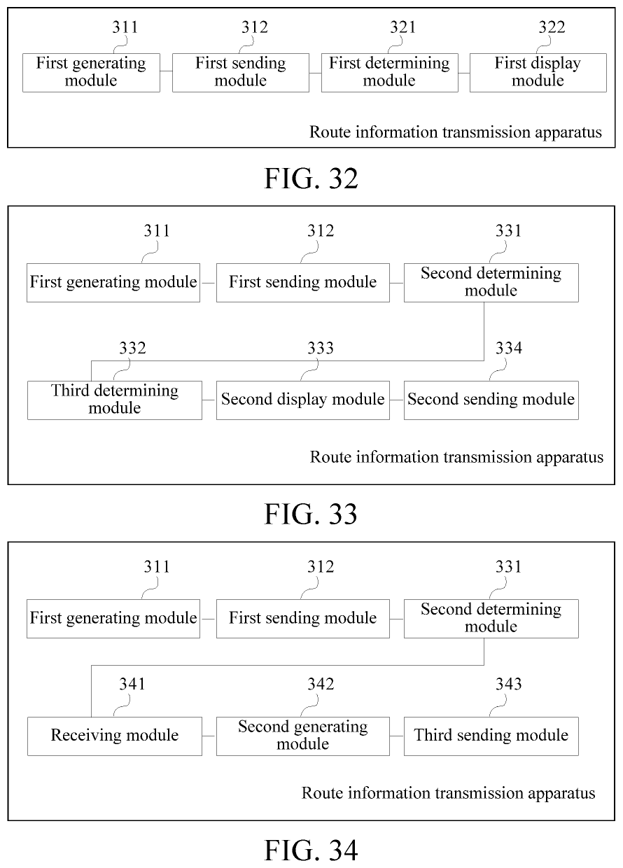

FIG. 32 is a schematic structural diagram of further another route information transmission apparatus according to an embodiment of the present application. Based on the embodiment shown in FIG. 31, as shown in FIG. 32, the apparatus provided in this embodiment further includes:

a first determining module 321, configured to determine the first route task corresponding to the flight zone according to the zone information, where in this case, the first determining module 321 may perform step S92 in the method shown in FIG. 13; and

a first display module 322, configured to display the first route task, where in this case, the first display module 322 may perform step S93 in the method shown in FIG. 13.

The first sending module 312 is specifically configured to:

send the route description information including the zone information to the UAV if a confirm operation of a user for the flight route is detected, where in this case, the first sending module 312 may perform step S94 in the method shown in FIG. 13.

For this embodiment, reference may be made to the technical solutions of the embodiments shown in FIG. 13 to FIG. 16. The implementation principle and technical effect of this embodiment are similar to those of the embodiments shown in FIG. 13 to FIG. 16. Details are not described herein again.

FIG. 33 is a schematic structural diagram of further another route information transmission apparatus according to an embodiment of the present application. Based on the embodiment shown in FIG. 31, as shown in FIG. 33, the apparatus provided in this embodiment further includes:

a second determining module 331, configured to: if a task execution failure message fed back by the UAV with respect to the first route task is received, determine a task that fails in execution in the first route task, where in this case, the second determining module 331 may perform steps S174-S175 in the method shown in FIG. 17;

a third determining module 332, configured to re-determine a second route task according to the task that fails in execution, where in this case, the third determining module 332 may perform step S176 in the method shown in FIG. 17;

a second display module 333, configured to display the second route task, where in this case, the second display module 333 may perform step S177 in the method shown in FIG. 17; and

a second sending module 334, configured to: if a confirm operation of the user for the second route task is detected, send a control instruction to the UAV, so that the UAV executes the second route task after receiving the control instruction, where in this case, the second sending module 334 may perform step S178 in the method shown in FIG. 17.

For this embodiment, reference may be made to the technical solutions of the embodiments shown in FIG. 17 to FIG. 19. The implementation principle and technical effect of this embodiment are similar to those of the embodiments shown in FIG. 17 to FIG. 19. Details are not described herein again.

FIG. 34 is a schematic structural diagram of further another route information transmission apparatus according to an embodiment of the present application. Based on the embodiment shown in FIG. 31, as shown in FIG. 34, the apparatus provided in this embodiment further includes:

a receiving module 341, configured to receive an update operation of the user for the first route task, where in this case, the receiving module 341 may perform step S184 in the method shown in FIG. 20;

a second generation module 342, configured to generate updated route description information according to the update operation, where the updated route description information includes updated waypoint information or updated zone information, and in this case, the second generation module 342 may perform step S185 in the method shown in FIG. 20; and

a third sending module 343, configured to send the updated route description information to the UAV, so that the UAV updates the first route task to be a third route task according to the updated route description information, where in this case, the third sending module 343 may perform step S186 in the method shown in FIG. 20.

For this embodiment, reference may be made to the technical solutions of the embodiments shown in FIG. 20 to FIG. 21. The implementation principle and technical effect of this embodiment are similar to those of the embodiments shown in FIG. 20 to FIG. 21. Details are not described herein again.

An embodiment of the present application provides a route information transmission system. The system includes a UAV provided in FIG. 22 and a ground station provided in FIG. 23 to FIG. 24.

All or some of the foregoing embodiments may be implemented by software, hardware, firmware or any combination thereof. When implemented by software, all or some of the embodiments may be implemented in the form of a computer program product. The computer program product includes one or more computer instructions. When computer program instructions are loaded and executed on a computer, all or some processes or functions according to the embodiments of the present application are generated. The computer may be a general-purpose computer, a special-purpose computer, a computer network, or another programmable apparatus. The computer instruction may be stored in a computer readable storage medium, or transmitted from one computer readable storage medium to another computer readable storage medium. For example, the computer instruction may be transmitted from one website, computer, server or data center to another website, computer, server or data center in a wired manner (such as a coaxial cable, an optical fiber, or a digital subscriber line (DSL)) or a wireless manner (such as infrared, radio, or microwave). The computer readable storage medium may be any media accessible to the computer, or a data storage device including one or more available medium integrations, such as a server or a data center. The available medium may be a magnetic medium (such as a floppy disk, a hard disk, a magnetic tape), an optical medium (such as DVD), or a semiconductor medium (such as a solid state disk (SSD)).

A person skilled in the art should realize that, in the one or more foregoing examples, the functions described in the embodiments of the present application may be implemented by hardware, software, firmware or any combination thereof. When implemented by software, these functions may be stored in a computer readable medium or transmitted as one or more instructions or code on the computer readable medium. The computer readable medium includes a computer storage medium and a communications medium. The communications medium includes any medium that facilitates transfer of a computer program from one place to another place. The storage medium may be any available medium accessible to a general-purpose or special-purpose computer.

What is claimed is:

1. A route information transmission method, applied to an unmanned aerial vehicle (UAV), comprising:
receiving route description information sent by a ground station, wherein the route description information comprises zone information, and the zone information comprises location information of a flight zone;
determining a first route task corresponding to the flight zone according to the zone information; and
executing the first route task in the flight zone.

2. The method according to claim 1, wherein the determining the first route task corresponding to the flight zone according to the zone information comprises:
determining location information of a start waypoint and a route shape according to the zone information; and
determining a flight route in the first route task according to the location information of the start waypoint and the route shape.

3. The method according to claim 1, wherein the determining the first route task corresponding to the flight zone according to the zone information comprises:
determining waypoint information in the flight zone according to the zone information; and
determining a flight route in the first route task according to the waypoint information.

4. The method according to claim 3, wherein the determining waypoint information in the flight zone according to the zone information comprises:
determining, according to the zone information, location information of a start waypoint and location information of a terminal waypoint in the flight zone.

5. The method according to claim 1, wherein the determining a first route task corresponding to the flight zone according to the zone information comprises:
determining, according to the zone information, whether there exists a no-fly zone; and
if there exists a no-fly zone, determining a flight route that corresponds to the flight zone and avoids the no-fly zone.

6. The method according to claim 1, wherein after the determining the first route task corresponding to the flight zone according to the zone information, the method further comprises:
obtaining flight state information; and
determining, according to the flight state information, whether the first route task meets a first execution condition;
wherein the executing the first route task in the flight zone comprises:
executing the first route task in the flight zone if the first route task meets the first execution condition.

7. The method according to claim 6, further comprising:
sending first prompt information to the ground station if the first route task does not meet the first execution condition, so as to indicate that execution of the first route task fails.

8. The method according to claim 1, further comprising
in the process of executing the first route task, determining whether there exists a task that fails in execution; and
if there exists a task that fails in execution, after executing the first route task, determining a second route task according to location information corresponding to the task that fails in execution.

9. The method according to claim 8, further comprising:
sending a task execution failure message to the ground station if there exists a task that fails in execution.

10. The method according to claim 9, further comprising:
receiving a control instruction that is sent by the ground station with respect to the second route task; and
executing the second route task according to the control instruction.

11. The method according to claim 1, further comprising:
receiving updated route description information sent by the ground station, wherein the updated route description information comprises updated waypoint information or updated zone information; and
updating the first route task to be a third route task according to the updated route description information.

12. The method according to claim 11, further comprising:
determining, according to a current execution state of the first route task, whether the third route task meets a second execution condition;
executing the third route task if the third route task meets the second execution condition; and
sending second prompt information to the ground station if the third route task does not meet the second execution condition, so as to indicate that execution of the third route task fails.

13. A route information transmission method, applied to a ground station, comprising:
generating zone information according to a user operation, wherein the zone information comprises location information of a flight zone; and
sending route description information comprising the zone information to an unmanned aerial vehicle (UAV), so that the UAV determines a first route task corresponding to the flight zone according to the zone information.

14. The method according to claim 13, further comprising:
determining the first route task corresponding to the flight zone according to the zone information; and
displaying the first route task;
wherein the sending route description information comprising the zone information to a UAV comprises:
sending the route description information comprising the zone information to the UAV if a confirm operation of a user for the flight route is detected.

15. The method according to claim 13, further comprising:
if a task execution failure message fed back by the UAV with respect to the first route task is received, determining a task that fails in execution in the first route task;
re-determining a second route task according to the task that fails in execution; and
displaying the second route task.

16. The method according to claim 15, further comprising:
if a confirm operation of the user for the second route task is detected, sending a control instruction to the UAV, so that the UAV executes the second route task after receiving the control instruction.

17. The method according to claim 13, further comprising:
receiving an update operation of the user for the first route task;
generating updated route description information according to the update operation, wherein the updated route description information comprises updated waypoint information or updated zone information; and
sending the updated route description information to the UAV, so that the UAV updates the first route task to be a third route task according to the updated route description information.
